(19) United States
(12) Patent Application Publication
(10) Pub. No.: US 2015/0228004 A1
(43) Pub. Date: Aug. 13, 2015

(54) Smart Device Apps and Incentives For Encouraging The Creation and Sharing Electronic Lists To Imrpove Targeted Marketing While Preserving User Anonymity

(71) Applicants: Kristin Kaye Bednarek, Bethesda, MD (US); Michael David Bednarek, Bethesda, MD (US)

(72) Inventors: Kristin Kaye Bednarek, Bethesda, MD (US); Michael David Bednarek, Bethesda, MD (US)

(21) Appl. No.: 14/175,259

(22) Filed: Feb. 7, 2014

(51) Int. Cl. G06Q 30/06; G06Q 10/08; G06Q 30/02

(52) U.S. Cl. CPC G06Q 30/0633; G06Q 30/0255; G06Q 10/08355

(57) ABSTRACT

Systems, methods and applications for using electronic lists to facilitate commerce, excursion organization and political discourse are described. The cloud based infrastructure described supports smart device APPS that encourage users to create electronic lists that include information that can be searched and used for targeted marketing without compromising the anonymity of the users. By providing IT infrastructure that facilitates and encourages users to create and share multiple lists, the system makes it possible to provide vendors, suppliers, marketers and interest organizations with direct information that is more valuable that information inferred from web browsing or other indirect acts. The information obtained directly from the users can then be used to facilitate commercial and other transactions. Lists stored within the system may be used to facilitate a distributed distribution system using trusted drivers and authorized affiliates.

### BACKGROUND

1. Field of the Invention

Systems, methods and applications for using electronic lists to facilitate commerce, excursion organization and political discourse are described. The infrastructure described supports smart device APPS that encourage users to create electronic lists that include information that can be searched and used for targeted marketing without compromising the anonymity of the users. The infrastructure further supports a “trip sharing” energy consumption reducing distributed distribution ecosystem of trusted drivers and authorized affiliates delivering and/or fulfilling orders of others. By consolidating deliveries and optimizing and even eliminating trips, the distributed distribution systems described herein yield energy savings and greenhouse gas reduction by reducing greenhouse gas emission reduction associated with unnecessary trips and deliveries.

2. Background

The benefits of using lists as an organizational tool have long been known and are well-documented. As a recent example, list making is an important component of the Getting Things Done time-management method that is based on storing, tracking and retrieving the information related to the things that need to get done. The human brain's “reminder system” is seen as inefficient at reminding us of what we need to do at the time and place when we can do it. Consequently, lists of “next actions” stored by context act as an external support that ensures that we are presented with the right reminders at the right time. In this context, electronic list tools act as external memories, an application of distributed cognition.

Notwithstanding the benefits of using lists many, especially organizationally challenged people, do not use lists that the extent they could or should. There have been numerous efforts to automate list generation using IT resources. For example, “Remember the Milk” is a cross-platform (web-based) application created in 2004 that allows users to create multiple task lists from a computer or smartphone, both online and offline. Added tasks can be edited (or not) to include various fields; locations can be added, and an integrated Google Maps feature allows users to save commonly used locations. Tasks can also be organized by tags. Tasks can be postponed, and Remember the Milk will inform users of the number of times a given task has been postponed. Users may synchronize among multiple devices more than once a day and the application can be integrated with Microsoft Outlook, Gmail, and other services.

Another example, Wunderlist is an app for cloud-based task-project-management that allows users to manage their tasks from a smartphone, tablet and computer. Wunderlist was created in 2010 by a startup called 6Wunderkinder. Wunderlist allows users to create lists to manage their “next actions.” These lists can be shared with other Wunderlist users. Through “Detail View,” users can add due dates (including repeating due dates), reminders, subtasks, and notes to tasks. To-dos can also be organized with #hashtags. Using a feature known as “Mail to Wunderlist,” users can send or forward emails to me@wunderlist.com to add tasks to their Wunderlist accounts. With the company's browser extension known as “Add to Wunderlist”, content from Outlook.com, Gmail, Amazon, Etsy, YouTube, Ebay and Trip Advisor can be added to Wunderlist

There are numerous other examples, but known list generation and management tools fail to take advantage of the full benefit of list generation technology and also fail to create incentives to adequately encourage list generation.

### SUMMARY

The present invention relates to infrastructure and supported smart device APPS that encourage users to create electronic lists that include information that can be searched and used for targeted marketing without compromising the anonymity of the users. The invention also relates to systems, methods and applications for using electronic lists to facilitate commerce, excursion organization and political discourse, examples of which are described herein. The infrastructure further supports a “trip sharing” energy consumption reducing distributed distribution ecosystem of trusted drivers and authorized affiliates delivering and/or fulfilling orders of others. By consolidating deliveries and optimizing and even eliminating trips, the distributed distribution systems described herein yield energy savings and greenhouse gas reduction by reducing greenhouse gas emission reduction associated with unnecessary trips and deliveries.

The IT infrastructure and applications of the present invention supports the transformation of user created list data in combination with other data into useful outputs that benefit various users of the system including, without limitation, users who provide input used to create electronic lists (user generated lists), vendors, suppliers, excursion organizers and those interested in the opinions of issue voters. The result of the transformation of data according to the present invention can include, but is not limited to, printed or displayed lists, offers, promotions, advertisements and the like as well as transitory electrical signals and data stored in non-transitory computer-readable medium.

The present invention is based on the recognition that recent innovations in IT infrastructure create opportunity for improved list generation and management tools. Further, the invention is based on the recognition that the creation of lists by individuals can be very beneficial to those engaged in targeted marketing such as vendors, suppliers, excursion organizers and interest groups by creating opportunities to implement mutually beneficial applications and systems relating to marketing and commerce.

At present, many billions of dollars are spent on marketing and targeted advertising each year. Sophisticated systems have been developed to identify target customers by analyzing web browsing to infer what goods and services a consumer may be interested in and when they might be ready to buy. Similar analysis and sampling techniques are used by political parties and candidates to estimate what issues might be most important to voters. Simply put, billions of dollars are spent on guessing what others want. Why guess, when I'm willing to tell you? That is the basic insight that leads to the conclusion that there can be great value derived from creating tools to facilitate the creation and sharing of lists supported by incentives that encourage creation and sharing of lists. By providing IT infrastructure that facilitates and encourages users to create and share multiple lists, the system makes it possible to provide vendors, suppliers, marketers and interest organizations with direct information that is more valuable that information inferred from web browsing or other indirect acts. The information obtained directly from the users can then be used to facilitate commercial and other transactions. Exemplary applications are enabled by software engines using list based processes together with other hardware and software. By way of example, the invention provides an electronic list application; a group list engine; a polling engine; a payment engine; a recommendation engine; an inventory query engine; a purchase allocation engine; a trusted driver query engine supporting a distributed distribution process; an optimization engine; a logistics engine and a driver order and delivery engine. These features may be used in combination to encourage users to create electronic lists that include information that can be searched and used for targeted marketing without compromising the anonymity of the users. In addition, the features used in combination facilitate commerce, excursion organization and political discourse, examples of which are described herein. The infrastructure further supports the distributed distribution ecosystem of trusted drivers and authorized affiliates delivering and/or fulfilling orders of others.

### BRIEF DESCRIPTION OF THE DRAWINGS

FIG. 1 shows cloud based system infrastructure that allows communication and data exchange among the various users in a system operated by a system operator.

FIG. 2 shows an operating environment of exemplary client network devices.

FIG. 3 shows the functional architecture of the system of the electronic list system.

FIG. 4 shows the functional architecture of an exemplary vendor computer system.

FIG. 5 is a flow diagram detailing an exemplary electronic list application process.

FIG. 6 is a flow diagram detailing an exemplary group list engine process.

FIG. 7 is a flow diagram detailing an exemplary polling engine process.

FIG. 8 is a flow diagram detailing an exemplary payment engine process.

FIG. 9 is a flow diagram detailing an exemplary recommendation engine process.

FIG. 10 is a flow diagram detailing an exemplary inventory query engine process.

FIG. 11 is a flow diagram detailing an exemplary purchase allocation engine process.

FIG. 12 is a flow diagram detailing an exemplary trusted driver query engine process.

FIG. 13 is a flow diagram detailing an exemplary optimization engine process.

FIG. 14 is a flow diagram detailing an exemplary logistics engine process.

FIG. 15 is a flow diagram detailing an exemplary driver order and delivery engine [DODE] process using a store/SYSOP systems.

### DETAILED DESCRIPTION

An important aspect of the present invention is the provision of cloud based processing infrastructure. By sharing resources, it is possible to introduce resource intensive functionality such as advanced image recognition, deduplication, encryption and real time proximity determination in an APP that is accessible to users of comparatively simple network devices.

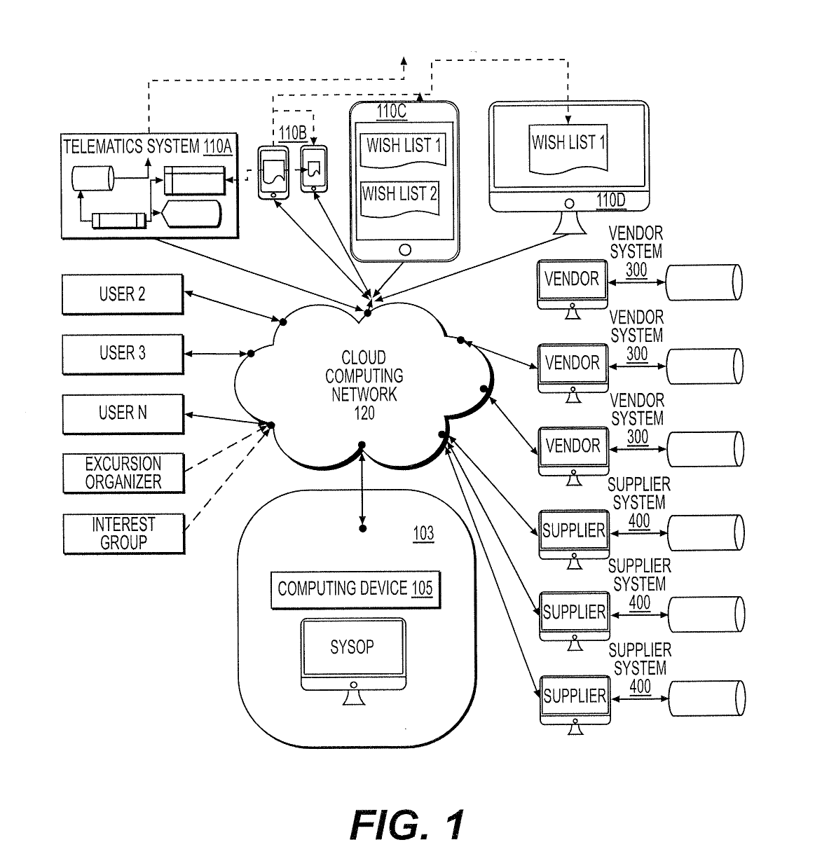

FIG. 1. shows exemplary system architecture at a high level. The system infrastructure is designed to facilitate the cloud based storage of data, the exchange of data among different types of system users, for example, USERS, VENDORS, ORGANIZERS, INTEREST GROUPS and SUPPLIERS through the system, the processing of data using cloud based resources and output of information to system users. The SYSTEM may be operated using cloud based resources and/or on proprietary infrastructure accessible through the cloud, i.e., the SYSOP hardware may be entirely or partially cloud based. The system hardware is described in further detail below, but one aspect of the hardware is cloud based storage of various types of data records as described below. The system of the invention also uses various software engines that may run on or across system operator infrastructure, user infrastructure or across platforms.

### User Records

While various types of users interact with the system, USERS refers to list creating users as opposed to VENDORS, SUPPLIERS and other users. A unique USER ID is created for each user and a USER PROFILE record is created for system users and associated with each USER ID. The profile record may include biographic/demographic information data, biometric ID information data, contact information data and affiliation information data. Location information and historical location information data may also be stored. To preserve anonymity, the USER ID is preferable an alphanumeric ID that doesn't reveal information that the USER wants to remain private. In particular, as described, the USER ID is used to associate user profiles that are not shared (to preserve anonymity) with USERS LISTS that may be shared, so USER ID itself is shared and shouldn't contain information that the USER wants to remain private.

Contact information can include phone numbers, addresses, e-mail addresses and social media profile names, for example. Contact information is used by the system operator (SYSOP) to exchange data (e.g., messages) between USERS and other users (e.g., VENDORS, SUPPLIERS, EXCURSION ORGANIZERS and INTEREST GROUPS) while preserving USER anonymity.

Affiliation information is information as to the groups that a user belongs to. Affiliations that are useful in the context of the present invention include, but are not limited to, family affiliation, household affiliation, work group affiliation, friendship affiliation, neighbor affiliation and interest affiliation. Affiliation information is provided by the USER. The USER may indicate an “affiliation” with one of more other users if they know the USER ID of the other USERS. Another way to establish affiliations among USERS is through the creation of GROUPS. Users can create GROUPS and invite other users to join based on family affiliation, household affiliation, work group affiliation, friendship affiliation, neighbor affiliation and interest affiliation. The system stores records of the GROUPS that can include records as to the USER ID and category of the groups. Naturally a single group of affiliated USERS may belong to multiple GROUPS or groups of different categories. Thus, for example, USERS who are members of the same household may belong to a grocery group, a shopping group a household task group and the like.

BIOMETRIC DATA is data that can be used for biometric authentication. As is known, biometric identifiers are the distinctive, measurable characteristics used to label and describe individuals. Examples include, but are not limited to, fingerprint, face recognition, DNA, Palm print, hand geometry, iris recognition, retina and odor/scent. Behavioral characteristics (behaviometrics) such as typing rhythm, gait, and voice may also be stored within the meaning of “biometric data” as used herein.

To use biometric data for identification, reference models for all the users are generated and stored in the model database. In Identification Mode the system performs a one-to-many comparison against a biometric database in attempt to establish the identity of an unknown individual. The system will succeed in identifying the individual if the comparison of the biometric sample to a template in the database falls within a previously set threshold. The first time an individual uses a biometric system is called enrollment. During the enrollment, biometric information from an individual is captured and stored. In subsequent uses, biometric information is detected and compared with the information stored at the time of enrollment.

By storing data related to multiple biometric markers, the system enables multimodal biometric identification. As know, multimodal biometric systems use multiple sensors or biometrics to overcome the limitations of unimodal biometric systems. For instance iris recognition systems can be compromised by aging irises and finger scanning systems by worn-out or cut fingerprints. While unimodal biometric systems are limited by the integrity of their identifier, it is unlikely that several unimodal systems will suffer from identical limitations. Multimodal biometric systems can obtain sets of information from the same marker (i.e., multiple images of an iris, or scans of the same finger) or information from different biometrics (requiring fingerprint scans and, using voice recognition, a spoken pass-code). Multimodal biometric systems can integrate these unimodal systems sequentially, simultaneously, a combination thereof, or in series, which refer to sequential, parallel, hierarchical and serial integration modes, respectively.

The USER RECORDS stored in the cloud may also include data used to implement user incentives such as past activity within the system. Examples of USER historical data include past list items, routes traveled (in store and outside travel) and past preferences.

### User Lists

User lists are lists created by input from USERS. The user input is stored as list items and the system includes APPS that allow the USERS to input list item data in a wide variety of ways using IT tools. Users may create multiple lists and every list a user creates is associated with the USER ID. In addition to the USER ID, each list record may also include data stored in fields to indicate the type or category of the list (e.g., grocery, shopping, excursion, policy issues), whether the USER LIST is public or private, who the list may be shared with (either by USER ID, group affiliation, user type (e.g., VENDORS, but not SUPPLIERS). Individual items can be identified as “personal” or “group” to assist to identifying duplicate items in consolidated lists.

### Vendor Records

VENDORS refers broadly to users who interact with the system in the context of selling or otherwise providing goods to USERS. This is in contrast to SUPPLIERS who supply goods or services to VENDORS. A unique VENDOR ID is created for each VENDOR and a VENDOR PROFILE record is created for system VENDOR users and associated with each VENDOR ID. The profile record may include location and hours of operation information data, contact information data, business category data (e.g., grocery, retail, travel etc) and affiliation information data (e.g., identification of related stores or branches). Contact information can include phone numbers, addresses, e-mail addresses and web addresses, for example.

The VENDOR RECORDS stored in the cloud may also include data used to implement user incentives such as past activity within the system. Vendors typically have their own vendor systems and the SYSOP may share resources with vendors so that software engines described herein are able to access multiple systems and even run across platforms.

### Supplier Records

SUPPLIERS refers broadly to those who supply goods or services to VENDORS.

A unique SUPPLIER ID is created for each SUPPLIER and a SUPPLIER PROFILE record is created for system SUPPLIER users and associated with each SUPPLIER ID. The profile record may include product/service offering information data, contact information data, business category data (e.g., grocery, retail, travel etc) and affiliation information data (e.g., identification of related SUPPLIERS or VENDOR affiliations. Contact information can include phone numbers, addresses, e-mail addresses and web addresses, for example.

The SUPPLIER RECORDS stored in the cloud may also include data used to implement user incentives such as past activity within the system.

### Group Records

As noted, records of the GROUPS are stored in cloud based computer readable media. The group records can include records as to the USER ID and category of the groups. The system can also create and store CONSOLIDATED LISTS for GROUP that identifies a set of USERS and a USER LISTS that pertain to a unique category, e.g., “BERKSHIRE HOUSEHOLD” grocery list. When CONSOLIDATED LISTS are stored in a computer readable medium, the CONSOLIDATED LISTS can be updated in real time when change is made to the items listed, e.g., when a USER adds an item or when an item is removed. However, the CONSOLIDATED LISTS can also be created on demand and need not be created or stored until a request for a CONSOLIDATED LIST is made (e.g., when a USER “checks in” to a VENDOR location).

To implement the methods of the present invention, the system preferably includes hardware and software resources including processor(s), Memory(ies), interface(s) and data store(s) for performing the following functions:

Synchronize USER LISTS across network devices associated with the same USER ID. This functionality may be performed locally and/or in the cloud.

Store USER PROFILES in non-transitory computer readable medium accessible by the SYSOP (system operator)

Store USER LISTS in non-transitory computer readable medium accessible by the SYSOP (system operator)

Store USER DATA in non-transitory computer readable medium accessible by the SYSOP (system operator)

Store PARTICIPATING VENDOR PROFILES in non-transitory computer readable medium accessible by the SYSOP (system operator). Vendors can include any provider of goods or services that can fulfill in whole or in part of list item.

A USER AFFILIATION GROUP LIST GENERATION ENGINE 171 for identifying USER LISTS associated with an AFFILIATION GROUP and generating a composite list. Such GROUP LISTS may be generated and stored in real time whenever a change is made to a USER LIST associated with the GROUP list or, alternatively, the GROUP LIST may be generated on demand (e.g., when a USER checks into a VENDOR location or upon request by a user).

Store USER AFFILIATION GROUP LISTS in non-transitory computer readable medium accessible by the SYSOP (system operator).

A DEDUPLICATION ENGINE 170 for removing undesired duplicate list items from a composite (consolidated) list. The DEDUPLICATION ENGINE 170 is used when combining user lists to identify and purge undesired duplicate list items. The DEDUPLICATION ENGINE 170 may include “confirm duplicate” functionality that, when enabled, prompts a user to confirm the addition or deletion of duplicate list items. If the functionality is not enabled, duplicate items can be automatically purged or automatically saved in a computer readable medium depending on user preference.

A RECOMMENDATION ENGINE 172 to identify and suggest related products or specials that are likely to be of interest to the customer.

A LOCATION ENGINE 173 that uses data identifying the user location together with stored vendor location information to determine proximity and, if desired, track and exchange information concerning USER location in relation to other users, e.g., VENDORS.

A PURCHASE ALLOCATION ENGINE 174 for assigning purchase responsibility to a particular group members based on a predetermined factor such as current proximity.

A PRODUCT IDENTIFICATION ENGINE for associating user input with a specific product.

AN INVENTORY QUERY ENGINE 175 for generating queries of participating vendors to ascertain where desired items can be found.

AN INCENTIVE ENGINE 176 for implementing one or more incentive programs.

AN IMAGE RECOGNITION ENGINE 177 uses available computer vision hardware and software to find and identify objects in an image or video sequence.

AN ENCRYPTION ENGINE 178 for encrypting data exchanged through the system.

A BIOMETRIC DATA ENGINE 179 for comparing and matching biometric data input to biometric data stored in association with a USER ID to identify users.

A PRICING ENGINE 181 for obtaining price/cost information from VENDORS and providing USERS the price of items on the list as well as a total price for all items on the list. The PRICING ENGINE and LOCATION ENGINE 173 may be used to ascertain the total cost of purchasing items on the list at various nearby vendors.

A PAYMENT ENGINE 180 that allows the SYSOP to act as a trusted intermediary to facilitate payment for goods or services without the need for USER payment information to be transmitted to other system users (e.g., VENDORS, SUPPLIERS, EXCURSION ORGANIZERS, INTEREST GROUPS). The payment engine 180 allows the SYSOP to transmit payment from a general payment account and then obtain reimbursement (and a service fee, if desired) using the USER payment information stored in the USER PROFILE.

A POLLING ENGINE 165 that allows users to “poll” other users by sending a message to select users to solicit, prompt or otherwise encourage the recipient users to generate a USER LIST 132. The polling engine 165 functionality is useful in various contexts depending on the APP being executed. In the context of the Cloud Enabled Issue Identification, the POLLING ENGINE 165 can be used to send requests to USERS to create lists in response to issues or questions accompanying the request. In the context of excursion organization, the POLLING ENGINE 165 can be used to solicit “wish lists” from USERS. In the context of shopping lists or ordering from a VENDOR, the POLLING ENGINE 165 may be used to alert other members of an affiliate group that one member is about to go shopping or place an order and prompt the other affiliate users to add any items they'd like to lists that will then be added to the consolidated GROUP list within a specified or predetermined time limit. Preferably all POLLING requests have a time limit for response to avoid an unnecessary delay in obtaining results.

A DATA STORE SEARCH ENGINE 155 for searching data stored within the system including USER LISTS, USER PROFILES, and VENDOR PROFILES. The engine indexes data from the various source within the system and also uses access controls to enforce a security policy.

A TRUSTED DRIVER QUERY ENGINE 183 (383) for allocating product/parcel deliveries to TRUSTED DRIVERS. The TRUSTED DRIVER QUERY ENGINE together with the LOGISTICS ENGINE (185) and DODE (390) supports a distributed distribution system according to the invention.

An OPTIMIZATION ENGINE 184 (384) for optimizing a selection among list items according to user preferences. For example, allocating JOB assignments to TRUSTED DRIVERS based on cost and objectively estimated delivery time according to a selected or predetermined user preference as to lowest cost or quickest delivery time.

A LOGISTICS ENGINE (185) for optimizing courier services and order/package/parcel deliveries in concert with the trusted driver query engine and optimization engine. A LIST EXCHANGE ENGINE for facilitating the exchange of electronic lists.

QR CODE GENERATING ENGINE 392 for generating a QR code that encodes (optionally) either the list itself (for direct transfer) or a link to a cloud based site for downloading the list per se.

A SCANNING ENGINE 385 for recognizing and associating physical items with list items stored in a user list. The scanning engine may operate in conjunction with the image recognition engine or a bar code reader for input.

STORE GUIDANCE ENGINE 386 for processing user location signals together with stored inventory data to generate signals displayed on the user device and/or hardware in the store.

ROUTE PLANNING ENGINE 387 for generating routes and direction for paths based on stored preferences including routes different from the most time/travel efficient paths but which satisfy stored user preferences.

DRIVER ORDER and DELIVERY ENGINE [DODE] 390 for facilitating pick-up and delivery of list items of other users, including trusted drivers and authorized affiliates.

ITEM LOCATION GUIDANCE ENGINE 388 for processing signals received from hardware within a facility and generating signals to activate and control item location guidance beacon equipment.

SYNCHRONIZATION ENGINE 160, 394 for synchronizing electronic lists across devices, platforms and among affiliates.

PEER-TO-PEER COMMUNICATION ENGINE 396 for facilitating real time communication between users in, for example, the DODE application.

The various software engines described herein and depicted herein may be implemented on and across various computing platforms including the system operators (SYSOP) platform and VENDOR computing system as well as local user devices. The depiction of engines used on a specific platform is not intended to be limiting.

As explained in further detail below, functionality such as advanced image recognition, deduplication, encryption and real time proximity can be very resource intensive. Performance may be improved dramatically by implementing a cloud based processing infrastructure that allows sharing of resources accessible to users of comparatively simple network devices. Moreover, cloud-based list management infrastructure can be used to support various distinct list-based APPS. For example, common infrastructure could be used to support a shopping/grocery APP, a group travel APP and a political issues APP.

The infrastructure outlined above and discussed further below can be used to support a wide variety of APPS that can be used on “smart devices” 110 (which includes phones, tablets, wearable computers (e.g., wristwatches, glasses), laptop computers, desktop computers, vehicle computer systems (both built-in and beamed in) and the like. The system also supports incentive engines running incentive programs to encourage the creation and sharing electronic lists to improve targeted marketing to facilitate commerce, excursion organization and political discourse. The infrastructure described supports the creation of storage of electronic list records that include information that can be searched and used for targeted marketing without compromising the anonymity of the users. The infrastructure further supports distributed order pick-up and delivery through an ecosystem of group members, trusted drivers and authorized affiliates. By consolidating deliveries and optimizing and even eliminating trips, the distributed distribution systems described herein yield energy savings and greenhouse gas reduction by reducing greenhouse gas emission reduction associated with unnecessary trips and deliveries. Several non-limiting examples of APPS are described below.

### Exemplary Application: Cloud Enabled Electronic Shopping Lists

The system infrastructure allows users to create and share multiple lists that can then be used to facilitate commercial and other transactions as well as distributed order fulfillment, distribution and delivery. Each list can be shared with particular affiliation groups so that, for example, a list coded for sharing with members of the same household will be accessible by all members of the household affiliate group, but not accessible to users who do not belong to that particular household group. A list coded for sharing with classmates will be accessible by all members of the classmate affiliate group, but not accessible to users who do not belong to that particular classmate group. A list coded for sharing with members of the same workgroup will be accessible by all members of the workgroup affiliate group, but not accessible to users who do not belong to that particular workgroup. By selecting a distributed order fulfillment and/or delivery option, the list is automatically coded for sharing with users, namely authorized affiliates and trusted drivers. For security and privacy reasons, the default is preferably no sharing unless the user affirmatively enables sharing.

As an example, the user could create a “wish list” of items that they intend to buy or would like to acquire. One example of a cloud enabled APP according to the present invention is a grocery list APP that can be run on any of the target devices (computers, phones, tablets, telematics etc). The user can use the APP to create the list by selecting items to add to the list from a menu or webpage, by inputting items though a touch screen interface, keyboard or voice input, by scanning a code such as a bar code or QR code. The user may also use a camera to image the desired item and the system could use image recognition software to identify the item imaged. In each instance and especially when image recognition is used, the user may be prompted to confirm the item to be added to the list. The user may also be prompted to identify the item as “PERSONAL” (e.g., a toothbrush) or “HOUSEHOLD” (e.g., paper towels), which helps in deduplication when lists of household members are merged.

So, for example, in a household with three members: Alexis, Bella and Callie, each member may create a list (which might be one of multiple lists associated with that user's USER ID) that is categorized as a HOUSEHOLD GROCERY LIST and coded for sharing among the three members of the affiliate group BERKSHIRE HOUSEHOLD. Alexis creates a list by, for example, using the APP running on a computer to enter “MILK” into the new item field—this generates a system query to see if a unique item can be identified. In this instance, multiple items are identified and the user (Alexis) is presented with one or more menu selections to narrow the selection criteria. For example, the system might ask “whole milk,” “2% milk,” “skim milk,” “almond milk” or “other.” The menu selections could permit identification of a specific brand or just a generic product category. Later, Alexis uses her smart phone to add COKE ZERO to her list by scanning the bar code of a can a COKE ZERO. Scanning the bar code generates a system query (e.g., using the PRODUCT IDENTIFICATION ENGINE) to see if a unique item can be identified. In this instance the product, COKE ZERO, is identified and the user is given the option to select a preference as to product size and packaging. Alexis then uses voice recognition of her tablet to add a third item to her list by saying “Macaroni & Cheese.” The voice command generates a system query to see if a unique item can be identified. In this instance the product type is identified and Alexis is given the option to select a preference as to product size and packaging. Alexis chooses KRAFT. In each instance, the items added to the list are synched among all of Alexis' input devices using the cloud computing network and a record of the list is maintained “in the cloud” understood as the SYSOP database. The record stored in the cloud would preferably include Alexis' unique USER ID, list affiliation data (i.e., the USER IDs of other users that have access to this list) and item data. So, in this example, the record would include the following:

| | |
|---|---|
| USER ID: | ALEXIS081301 |
| LIST NAME: | Grocery |
| LIST AFFILIATION: | BERKSHIRE HOUSEHOLD |
| LIST ITEMS: | 2% Milk - 1 gallon |
| | COKE ZERO - cans |
| | KRAFT Macaroni & Cheese |

The second household member, Bella, then uses the app running on her tablet device to scan the QR code associated with an advertisement she sees in a magazine for a recipe for green bean casserole. The recipe calls for three ingredients: fresh green beans, cream of mushroom soup and French fried onions. Scanning the QR code generates a system query to see if a unique item can be identified and a product identification engine recognizes the code as referencing a recipe and the three times called for in the recipe are identified. The system preferable prompts Bella to confirm each of the items and provides the option to select a preference as to brand, product size and packaging. Once confirmed, the items are added to Bella's list and a record is stored in the cloud as follows:

| | |
|---|---|
| USER ID: | BELLA110104 |
| LIST NAME: | Grocery |
| LIST AFFILIATION: | BERKSHIRE HOUSEHOLD |
| LIST ITEMS: | Fresh green beans |
| | Cream of mushroom soup |
| | French fried onions |

The third household member, Callie, then uses the app running on her smartphone to upload an image taken with the smartphone camera. The image depicts a bottle of catsup and uploading the image prompts the system to run an IMAGE RECOGNITION ENGINE routine (which may include a product identification routine) to see if a unique item can be identified. The system recognizes the product as catsup and then provides the option to select a preference as to brand, product size and packaging. Later, while browsing the web on her tablet, Callie notices an ad for LISTERINE mouthwash and, with the APP running in the background, Callie adds LISTERINE to her list by using the tablet's touch screen interface. At this point a record is stored in the cloud as follows:

| | |
|---|---|
| USER ID: | CALLIE030410 |
| LIST NAME: | Grocery |
| LIST AFFILIATION: | BERKSHIRE HOUSEHOLD |
| LIST ITEMS: | Ketchup |
| | LISTERINE |

Though separate records are stored for each group member, the system can also create and store a consolidated group list. In this example, the consolidated list record may contain the following information:

| | |
|---|---|
| LIST NAME: | Grocery |
| LIST AFFILIATION: | BERKSHIRE HOUSEHOLD |
| MEMBERS: | ALEXIS081301; BELLA110104; |
| | CALLIE030410 |
| LIST ITEMS: | 2% Milk - 1 gallon |
| | COKE ZERO - cans |
| | KRAFT Macaroni & Cheese |
| | Fresh green beans |
| | Cream of mushroom soup |
| | French fried onions |
| | Catsup |
| | LISTERINE |

The APP allows each user to view both their individual lists and the consolidated group lists of groups that they are members of. So, in the example described above, Bella may have created various lists using the app such the Grocery list described above, a To-Do list, a Gift Wish List and so on. When Bella goes to the grocery store she can “check in” by identifying herself as a system user and providing her USER ID along with an indication of which lists may be shared with the VENDOR (in the instance the grocery store that participates in the system). Some preferences may be stored in the USER profile record. The “check in” process may be accomplished through biometric identification as Bella enters the store, accord swipe, input into a check in station or by providing her USER ID whether physically or by reading the user ID from a smart device or tag (such as an RFID tag) associated with Bella. Upon check-in (regardless of how it is accomplished), the VENDOR is identified and the system allows the VENDOR access to the USER's list to the extent authorized by the USER. In this example, BELLA and other group members have authorized participating grocery stores to have access to the GROCERY list. Thus, upon check-in, the BERKSHIRE HOUSEHOLD grocery list record is retrieved and transmitted to the VENDOR through the Cloud Computing Network. The Vendor uses the record it receives to present relevant information to the user through the APP. The data presented to the USER can vary according to the VENDOR preference, but in this example, the grocery store may provide the following information:

Hello Bella!
We have all your items:

| YOUR ITEMS: | Location: |
|---|---|
| Fresh green beans | PRODUCE |
| 2% Milk - 1 gallon | DIARY Aisle 1 Section 7 |
| KRAFT Macaroni & Cheese | Aisle 3, Section 8 |
| Cream of mushroom soup | Aisle 4, Section 5 |
| French fried onions | Aisle 4, Section 6 |
| Catsup | Aisle 5, Section 5 |
| COKE ZERO - cans | Aisle 8, Section 7 |
| LISTERINE | Aisle 12, Section 3 |

As shown, the VENDOR system makes the shopping experience very pleasant for Bella by identifying specific item locations and listing the items according to location to make the shopping experience more efficient. The vendor infrastructure may also provide other features described herein including in store guidance, hand held scanners (or scanning apps) for smart devices and item location beacons. To some extent, making the shopping experience more efficient is counter to conventional retail wisdom that holds that it is better to cause customers to wander to improve the possibility of “impulse” purchases. However, it is important to recognize that the VENDOR obtains valuable information when customers use the APP and by leveraging this information the VENDOR may find that there are various ways to improve revenues even as they improve the customer experience and generate customer loyalty. For example, because the VENDOR knows exactly what the USER is looking for upon check-in, they can use a recommendation engine 172 to identify and suggest related products or specials that are likely to be of interest to the customer. Moreover, the route planning engine may be used to guide the user along a path that is not the most time/distance efficient but instead satisfies stored preferences.

In this example, the USER (Bella) could invite other members of the household to add any “last minute” items to their order list (and the consolidated order list) by using the POLLING ENGINE 165 to alert other household members that she is about to go grocery shopping (i.e., place a grocery order) and prompt the other household members to add any items they'd like to lists that will then be added to the consolidated GROUP list within a specified or predetermined time limit. The POLLING request should have a reasonably brief time limit for response to avoid an unnecessary delay in confirming and processing the order.

If authorized by the USER, VENDOR customer analytics systems (often supported by outside providers) could be given access to select data in the DATA STORE to facilitate location based marketing technology using a network of sensors in business locations to track USER movement by connecting with WiFi enabled smart devices as they move through a venue. Currently available sensors, each about the size of a deck of cards, follow signals emitted from Wi-Fi-enabled smartphones. In store position systems (IPS) may also be used. Smart device users broadcast their location from phones when WiFi is enabled a network of sensors can track any phone that has Wi-Fi turned on, enabling the company to build profiles of USER's lifestyles. Alternatively, phone-signal data from cellphone carriers can be processed by signal processing engines that include algorithms then break those users into lifestyle categories based on their daily travels, which it says it can track down to the square meter.

In addition, SUPPLIERS of products sold by the VENDOR can be provided access to system to varying extents. For example, the SUPPLIER system could be notified that a USER that is presently in a VENDOR location intends to buy a specific product that has some association with the product the SUPPLIER provides. For example, the product that the USER is about to buy might be a competitive product, or a product that is complementary to the SUPPLIER's product or a particular variant of one of SUPPLIER's own products. In any case, the awareness of the user's imminent purchase is information that might be valuable to the SUPPLIER. For example, if the USER is about to purchase a competitive product, the SUPPLIER could use the system infrastructure to present the USER with an attractive offer to buy their product instead. This is possible because all necessary data is stored in or accessible through the system including USER LIST and USER contact information. Moreover, if enabled by the VENDOR, the system can obtain price information from the vendor through an inventory query engine of search of inventory records.

In the example detailed above, the VENDOR, a grocery store, had each of the items on a comparatively simple grocery list. In some instances a vendor will not have items on a user's list. In those instances, the VENDOR may indicate which items are available (by highlighting for example) and possibly offering substitutes for items not available using the recommendation engine 172.

In accordance with another aspect of the invention, the system has an inventory query engine to generate INVENTORY QUERIES of participating vendors to allow users to ascertain where desired items can be found. The system preferably maintains a record of the location of all participating vendors so that the system can identify the nearest vendor or all vendors within a selected range. The inventory query engine 175 may also obtain price and quantity information to provide to the user. To the extent pricing information can be obtained from VENDORS, the system can run PRICING ENGINE to obtain and display the price of items on the list as well as a total price for all items on the list. By obtaining pricing information from more than one nearby VENDOR, the system can use the PRICING ENGINE and LOCATION ENGINE 173 to ascertain the total cost of purchasing items on the list at various nearby vendors. Because there will likely be resistance to sharing business information, it is important to provide incentives to USERS, VENDORS and SUPPLIERS to share information with the system.

Many of the user devices according to the present invention include position locating equipment such as a GPS chip or WiFi transmission equipment that allow the system to ascertain the user's location. The system includes a LOCATION ENGINE 173 that uses data identifying the user location together with stored vendor location information to determine proximity.

In accordance with an aspect of the present invention, the system may include a PURCHASE ALLOCATION ENGINE 174 to assign purchase responsibility to particular group members based on their current proximity (as ascertained by the LOCATION ENGINE 173) to particular vendors. Thus, for example, if a group list includes items that are best purchased at two or more vendors based on price or availability, the PURCHASE ALLOCATION ENGINE 174 can analyze the list to ascertain the preferred (or optimal vendor) for each item and then allocates purchase responsibility to the group member located nearest to that vendor. The group member is preferably given the option to decline the purchase responsibility, in which case the system reallocates the purchase responsibility. It will be understood that this feature is useful for reducing the collective cost and/or burden of purchases among a group when there are price variations or challenges associated with product availability.

### Longer Term Lists

The forgoing example emphasizes advantages of the invention in the context of lists of comparatively short term needs, e.g., groceries. The invention is also useful in sharing lists of “long term” wish lists or goals. A user may, for example, compile a list of items they want and share the list with those who might be inclined to buy items for the user, e.g., family and friends. Encouraging users to create longer term “wish lists” or aspirational lists also creates possibilities for improved commerce according to aspects of the invention. As an example, when users of the system compile lists of items that they are ready to buy or considering buying, the list data stored in the cloud is valuable to vendors of goods or services who are able to search the cloud data for users who are interested in buying the goods or services that the vendor is selling. Naturally, it is expected that the users would have to agree to allow searches of their respective lists. To encourage USER participation and consent to searches of their data, the system includes an INCENTIVE ENGINE 176 for implementing one or more incentive programs. To encourage users to “check in” with participating vendors, users could be awarded points, rebates or discounts for checking in. USERS may also be provided with bulk discounts, group discounts, area discounts all of which may be coordinated by the incentive engine 176. Likewise, users who purchase items from participating vendors that targeted them through the system could be awarded points, rebates or discounts.

From the perspective of VENDORS, the system provides valuable marketing information including the possibility of obtaining list with contact information of users that are actively interested in the product or service the vendor offers.

### Exemplary Application: Cloud Enabled Drive-thru Pick Up Based on Electronic Lists

As noted, the system infrastructure allows users to create and share multiple lists that can then be used to facilitate commercial and other transactions. To the extent a USER LIST or GROUP LIST includes items that can be obtained from a VENDOR or SUPPLIER that offers drive-thru pick up, a USER may use the system to transmit the list to a VENDOR or SUPPLIER location for pick up. With a smart device that includes a display screen, the VENDOR or SUPPLIERS “menu” of goods may be displayed on the USER's smart device to allow the USER to add items to the USER LIST that is subsequently transmitted to the VENDOR or SUPPLIER. As one example, when the VENDOR is a “fast food” restaurant, the VENDOR could provide its menu through the system or through a separate web enabled interface to a USER's smart device, which might be a vehicle telematics system or a separate smart phone or tablet. The USER could add menu items to an ORDER LIST and then authorize the transfer of the order list to the VENDOR. When the USER smart devices include position locating equipment (e.g., GPS) the system could also notify the VENDOR of the estimated time of arrival for pick up (if the USER is traveling) and update the ETA as the USER nears the VENDOR location eventually notifying the VENDOR when the USER has arrived at the location. Delivery of the goods could take place in various ways without compromising the personal anonymity of the USER. The same approach may be used to alert a vendor of the impending arrival of a trusted driver or authorized affiliate driver.

The USER could invite other affiliate members (e.g., other members of the household) to add their order list to a consolidated order list by using the POLLING ENGINE 165 to alert other members of an affiliate group that the USER member is about to place an order and prompt the other affiliate users to add any items they'd like to lists that will then be added to the consolidated GROUP list within a specified or predetermined time limit. The POLLING request should have a brief time limit for response to avoid an unnecessary delay in confirming and processing the order. Sharing order fulfillment (pick-up) responsibility and consolidating deliveries combined with optimizing and even eliminating trips yield energy savings and greenhouse gas reduction by reducing greenhouse gas emission reduction associated with unnecessary trips and deliveries.

The USER PROFILE record 131 could, if desired, include payment information sufficient to allow electronic payment through the system or the transfer of secure electronic payment information to a VENDOR upon authorization from the USER. The VENDOR could receive a description of the USER vehicle or the VENDOR could send the USER an order number for display or the VENDOR could instruct the USER to PARK at a designated location (e.g., parking space) that has been allocated to the order.

Thus, by way of example, a USER named Michael is driving in his telematics equipped vehicle and uses the interface to pull up the menu for BIG BURGERS (a fast food franchise). Michael selects a BIG BURGER location from a list of nearby locations and proceeds to create an ORDER LIST by making menu selections and transmits the order. Optionally, Michael may indicate that the ORDER LIST is GROUP list that is not yet complete designating a group such as FAMILY. Other members of the group “FAMILY” are then prompted (e.g., by SMS message) to add ITEMS to the list, if desired. Since some GROUP members may be unable to or uninterested in responding, the system would (as a default that could be overridden) consider the ORDER LIST complete after a predetermined time (e.g., 10 minutes) had elapsed. In this example, another family member, Kristin creates an order list that is consolidated with the FAMILY order list. The remaining family members either opt out or do not respond in time, so the group ORDER list is deemed complete and transmitted to the designated BIG BURGERS location, preferably through the system. If desired, Michael can also transmit payment information from a record of payment information stored in the system or by inputting payment information. In addition to the ORDER LIST and payment information (optionally) Michael's current location and expected time of arrival could be transmitted to the BIG BURGERS location and this information could be updated as Michael nears the location. As Michael approaches the location, the BIG BURGERS location transmits a message instructing Michael to park in location #37. Upon arrival, the system alerts BIG BURGERS that Michael has arrived (or the arrival of the vehicle is detected by BIG BURGERS) and the competed order is delivered to Michael's vehicle.

Those skilled in the art will appreciate that aspects of this “drive thru” pick up system could be implemented by a wide variety of VENDORS and SUPPLIERS to facilitate the delivery of a wide variety of goods in an efficient convenient manner. Moreover, the distributed order fulfillment and distribution systems yield energy savings and greenhouse gas reduction by reducing greenhouse gas emission reduction associated with unnecessary trips and deliveries. When implemented to the full extent, the VENDOR or SUPPLIER could eliminate retail space entirely and simply store goods for delivery to those who use the drive thru “pick up.” For example, a grocery store could assemble all items on a grocery list into a packed order that is delivered to a USER or USER vehicle upon arrival at the grocer's location. The same approach could be used for hardware stores and other retailers.

Anonymity is not always important to users. To the contrary, there are instances when a USER may want to be acknowledged, e.g., to be rewarded as a “regular” customer. However, when anonymity is important, the system can preserve anonymity by limiting the extent to which personal information stored in a USER PROFILE is made available to others. Thus, even in the example above where an order is delivered directly to a USER's vehicle, the entire transaction can occur without the VENDOR receiving an USER information other than the USER order and location. In such a circumstance, the SYSOP would act as a trusted intermediary for the transaction payment so that the USER's payment information need not be transmitted to the VENDOR.

### Exemplary Application: Cloud Enabled Excursion Organization Based on Electronic Lists

As noted, the system infrastructure allows users to create and share multiple lists that can then be used to facilitate commercial and other transactions. Each list can be designated as private, public or available for sharing to designated users. For example, a list may be shared with particular affiliation groups as described above. A USER LIST132 may also be designated as accessible to searches by other users, including VENDORS 300, SUPPLIERS 400, interest groups and EXCURSION ORGANIZERS. Importantly, when, as preferred, the USER PROFILES 131 and stored separately from the USER LISTS 132 it is possible for other users to search stored USER LISTS 132 without knowing the identity or contact information of the user who created the USER LIST. The ability of a user to contact the creator of a USER LIST is controlled by the SYSOP to preserve anonymity. Anonymity is important to encourage USERS to create USER LISTS without unsolicited contact or loss of privacy. However, to the extent a USER is willing to allow unauthorized contact from other users; the system allows the SYSOP to pass messages from other users to USERS without revealing the USERS contact information. With this functionality, USERS can receive offers, advertising, invitations and the like based on their actual preferences as expressed in USER LISTS that they created. By providing IT infrastructure that facilitates and encourages users to create and share multiple lists, the system makes it possible to provide vendors, suppliers, marketers and interest organizations with direct information that is more valuable that information inferred from web browsing or other indirect acts. The information obtained directly from the users can then be used to facilitate commercial and other transactions including highly targeted marketing.

Another exemplary APP using this infrastructure is an EXCURSION ORGANIZER APP. In this example, the users could create a “wish list” of excursions that they are interested in. The excursions could be any group activity or adventure made for leisure, education, business, holiday or physical purposes ranging from a partial day event to an extended journey. Excursions are often visits to one or more places or sites that people want to see or events people want to attend or experiences (e.g., “bucket list”) that people hope to have in their lifetime. The infrastructure of the present invention is especially useful in organizing excursions that entail identifying and assembling a group of two or more people interested in the same excursion.

An exemplary cloud enabled EXCURSION ORGANIZER APP according to the present invention works with USER created “wish lists” or “bucket lists” of excursions that the USER is interested in taking. The USER LIST can be created on a list APP that can be run on any of the target devices (computers, phones, tablets, etc). The user can use the APP to create the list by selecting items to add to the list from a menu or webpage, by inputting items though a touch screen interface, keyboard or voice input, by scanning a code such as a bar code or QR code. The user may also use a camera to image a particular sight (landmark) and the system could use image recognition software (e.g., Google Goggles) to identify the sight imaged. In each instance and especially when image recognition is used, the user may be prompted to confirm the item to be added to the list. The user may also be prompted to identify a budget range that they are willing to spend of the excursion as well as a time frame of availability. Importantly, the USER LISTS 132 used in this APP need not be created solely for use with this APP. To the contrary, it is expected that creation of “wish lists” or “bucket lists” is common among users of electronic list tools. However, the user must have authorized (at least by default, if not affirmatively) the system to permit searching of the USER LIST 132 by users of the EXCURSION ORGANIZER APP. The POLLING ENGINE 165 may be used to solicit “wish lists” from USERS.

The EXCURSION ORGANIZER may organize excursions, including highly customized excursions, by identifying groups of USERS who share an interest in an excursion that includes one or more of the items on their wish list. Again, the ability of an EXCURSION ORGANIZER to contact the creator of a USER LIST is controlled by the SYSOP to preserve anonymity. Anonymity is important to encourage USERS to create USER LISTS without unsolicited contact or loss of privacy. However, to the extent a USER is willing to allow unauthorized contact from other users; the system allows the SYSOP to pass messages from other users to USERS without revealing the USERS contact information. The SYSOP can also pass USER location information to the EXCURSION ORGANIZER to the extent authorized by the USER. For example, a USER may allow the SYSOP to disclose that she is located in Montgomery County, MD without loss of anonymity. A USER may also allow the SYSOP to disclose her budget and timing expectations for the excursions listed.

Thus, with the infrastructure of the present invention, EXCURSION ORGANIZER may use the EXCURSION ORGANIZER APP to find targets for established excursion itineraries. Moreover, an EXCURSION ORGANIZER may use the EXCURSION ORGANIZER APP to customize excursion itineraries that exactly meet a USER'S budget and excursion objectives. In this way, the EXCURSION ORGANIZER uses the EXCURSION ORGANIZER APP to create new “product” offerings that are tailored precisely to the wishes of target customers. This is just one example of “mass customization” using the infrastructure of the present invention to provide USERS with offers, advertising, invitations and the like based on their actual preferences as expressed in USER LISTS 132 that they created. By providing IT infrastructure that facilitates and encourages users to create and share multiple lists, the system makes it possible to provide vendors, suppliers, marketers and interest organizations with direct information that is more valuable that information inferred from web browsing or other indirect acts.

As an example, suppose the DATA STORE 130 includes the USER LISTS 132 below, each of which has a category designation of “wish list” or “bucket list.” For simplicity, assume that the USERS identified below (Dick, Roger, Sally, Jane and Jack) are all from the same general geographic area (which can be ascertained from the USER PROFILES 131 and LOCATION ENGINE 173).

### USER: DICK050394

| | | |
|---|---|---|
| Eiffel Tower | not specified | any summer |
| Neuschwanstein Castle | not specified | any summer |
| Coliseum, Rome | not specified | any summer |
| Leaning Tower, Pisa | not specified | any summer |

### USER: ROGER042597

| | | |
|---|---|---|
| Statue of Liberty, NY | not specified | 2014 |
| Empire State Building, NY | not specified | 2014 |
| Golden Gate Bridge | not specified | 2014 |
| Big Ben, London | not specified | 2014 |
| Coliseum, Rome | not specified | 2014 |
| St. Peter's, Rome | not specified | 2014 |
| Acropolis, Athens | not specified | 2014 |
| Grand Canyon, AZ | not specified | 2014 |
| Sydney Opera House | not specified | 2014 |
| Great Wall of China | not specified | 2014 |
| Pyramids, Egypt | not specified | 2014 |
| Venice, Italy | not specified | 2014 |
| Rio de Janeiro, Brazil | not specified | 2014 |
| Machu Picchu, Peru | not specified | 2014 |
| Taj Mahal, India | not specified | 2014 |
| Eiffel Tower | not specified | 2014 |
| Neuschwanstein Castle | not specified | 2014 |
| Coliseum, Rome | not specified | 2014 |
| Leaning Tower, Pisa | not specified | 2014 |

### USER: SALLY030664

| | | |
|---|---|---|
| New York City | $1000 | Christmas Time |
| Empire State Building, NY | not specified | any time |
| Broadway Show | not specified | any time |
| Liberty Bell | not specified | any time |
| Coliseum, Rome | $3000 | any time |
| St. Peter's, Rome | $3000 | any time |
| Trevi Fountain, Rome | $3000 | any time |
| Vatican Museum | $3000 | any time |
| Venice, Italy | $3000 | any time |
| Leaning Tower, Pisa | $3000 | any time |

### USER: JANE042757

| | | |
|---|---|---|
| Statue of Liberty, NY | $1000 | any time |
| Broadway Show | not specified | any time |
| Empire State Building, NY | $1000 | any time |
| Golden Gate Bridge | $1000 | any time |
| Grand Canyon, AZ | not specified | any time |
| Great Wall of China | not specified | any time |
| Beijing, China | not specified | any time |
| Hangzhou, China | not specified | any time |
| Shanghai, China | not specified | any time |

### USER: JACK022012

| | | |
|---|---|---|
| NBA GAME, NY | not specified | any time |
| Empire State Building, NY | not specified | any time |
| Coliseum, Rome | not specified | any time |
| St. Peter's, Rome | not specified | any time |
| Acropolis, Athens | not specified | any time |
| Venice, Italy | not specified | any time |
| Rio de Janeiro, Brazil | not specified | any time |
| Machu Picchu, Peru | not specified | any time |
| Coliseum, Rome | not specified | any time |
| Leaning Tower, Pisa | not specified | any time |

An EXCURSION ORGANIZER using the EXCURSION ORGANIZER APP could ascertain that an excursion to Italy in the Summer of 2014 would likely be highly appealing to Jack, Sally, Roger and Dick if the EXCURSION could be priced at $3000 or less and included visits to the Coliseum and St. Peter's in Rome with options to visit Venice, Pisa or stay in Rome to see Trevi Fountain and the Vatican Museum.

Likewise an EXCURSION ORGANIZER using the EXCURSION ORGANIZER APP could ascertain that an excursion to New York City at Christmas time 2014 would likely be highly appealing to Roger, Sally, Jane and Jack if the EXCURSION could be priced at $1000 or less and include a visit to the Empire State Building with options for an NBA Game, a Broadway Show and or a visit to the Statue of Liberty.

These simple examples demonstrate how an EXCURSION ORGANIZER may use the EXCURSION ORGANIZER APP to customize excursion itineraries that exactly meet a USER'S budget and excursion objectives. In this way, the EXCURSION ORGANIZER uses the EXCURSION ORGANIZER APP to create new “product” offerings that are tailored precisely to the wishes of target customers.

### Exemplary Application: Cloud Enabled Issue Identification Based on Electronic Lists

Those involved in the field of electoral politics and policy advocacy, spend many millions of dollars in polling and other research trying to ascertain which issues are most likely to influence a voter's vote. The theory of “issue voting” holds that voters cast their vote in elections based on specific political issues. In the context of an election, issues include “any questions of public policy that have been or are a matter of controversy and are sources of disagreement between political parties.” According to the theory of issue voting, voters compare the candidates' respective principles against their own to decide for whom to vote. A voter does not need to have an in-depth understanding of every issue and knowledge of how a candidate stands on every issue, but rather a sense of which candidate they agree with the most.

Issue voting is often contrasted with party voting. Voters switch between issue voting and party voting depending on how much information is available to them about a given candidate. Low-information elections, such as those for congressional candidates are determined by party voting, whereas presidential elections, which tend to give voters much more information about each candidate, have the potential to be issue-driven. Voters typically choose a political party to affiliate with in one of two ways. The voter will create an opinion of an issue without consulting what a political party thinks about it, then choose the political party that best fits the opinion they already have, or the voter will study the opinions of the different parties and decide which party he or she agrees with the most.

To target issue voters, it is useful to understand issues that are most likely to influence voters. While there are a various techniques for inferring this information, the infrastructure of the present invention makes it possible for those involved in the field of electoral politics and policy advocacy to receive direct input from voters as to which issues are most important to the voters.

As noted, the system includes a POLLING ENGINE 165 that allows users to “poll” other users by sending a message to select users to solicit, prompt or otherwise encourage the recipient users to generate a USER LIST. The polling engine 165 functionality can be used to send requests to USERS to create lists in response to issues or questions accompanying the request.

Again, the ability of an INTEREST GROUP to contact the creator of a USER LIST is controlled by the SYSOP 103 to preserve anonymity. Anonymity is important to encourage USERS to create USER LISTS without unsolicited contact or loss of privacy. However, to the extent a USER is willing to allow unauthorized contact from other users; the system allows the SYSOP to pass messages from other users to USERS without revealing the USER'S contact information. The SYSOP can also pass USER location information to the INTEREST GROUP to the extent authorized by the USER. For example, a USER may allow the SYSOP to disclose that she is located in a particular political district (e.g., Montgomery County, MD) without loss of anonymity.

An exemplary cloud enabled ISSUE IDENTIFICATION APP according to the present invention allows USERs to create “issue lists” of issues that they are passionate about together with an indication of the importance of the issue to their vote. The user can use the APP to create the list by selecting items to add to the list from a menu or webpage, by inputting items though a touch screen interface, keyboard or voice input. The information that INTEREST GROUPS can obtain through this system allow the INTEREST GROUPS to understand which issues are important to issue voters and to target messaging.

While the foregoing examples demonstrate some of the APPS supported by the hardware and software infrastructure of the invention, those skilled the art will recognize that there are other APPS possible using this infrastructure.

In the following discussion, a further description of the system and its components is provided, followed by a discussion of the operation of the same. This disclosure describes systems and methods for processing list information to aide users in achieving objectives and facilitating commerce. More specifically, the system and method facilitate and encourage the creation of user generated lists and the sharing of list and user information in a cloud environment. In the context of this disclosure, a product can include a good, service or any combination thereof.

Various infrastructures may be used to implement the system and method of the present invention. An example of the networked environment is depicted in FIG. 1. As shown, the networked environment 100 networked environment includes one or more computing devices 105 and/or clients 110(a-d) that can be in communication via the network 120. The network 120 includes, for example, the Internet, intranets, extranets, wide area networks (WANs), local area networks (LANs), wired networks, wireless networks, or other suitable networks, etc., or any combination of two or more such networks.

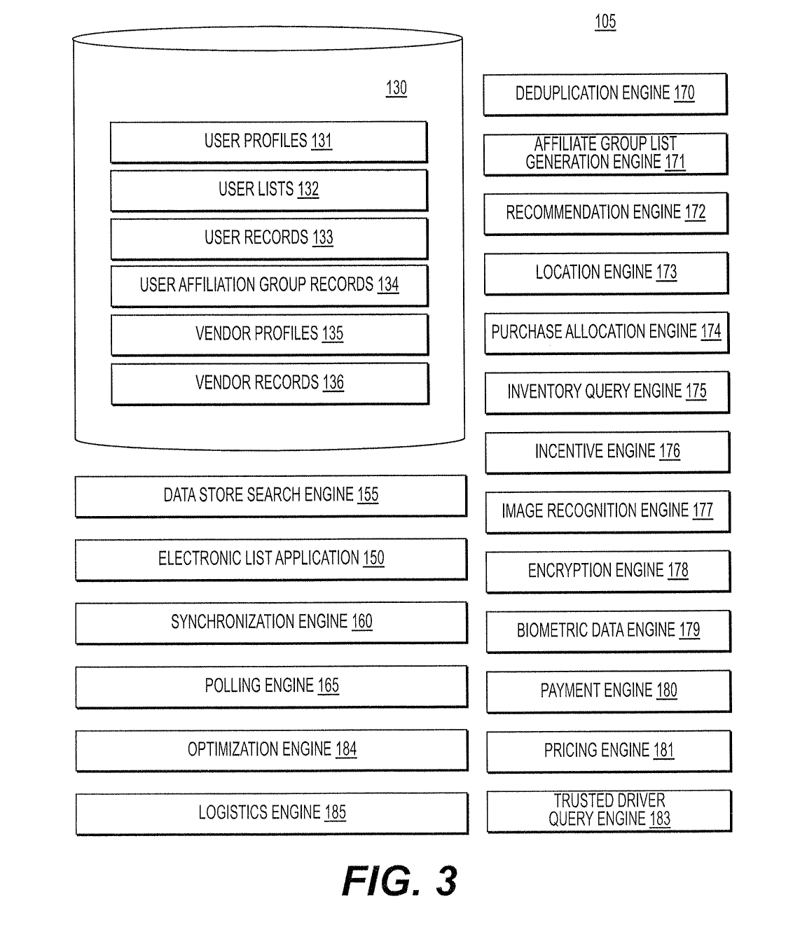

The computing device 105 may comprise, for example, a server computer or any other system providing computing capability. Alternatively, a plurality of computing devices 105 may be employed that are arranged, for example, in one or more server banks or computer banks or other arrangements. A plurality of computing devices 105 together may comprise, for example, a cloud computing resource, a grid computing resource, and/or any other distributed computing arrangement. Such computing devices 105 may be located in a single installation or may be dispersed among many different geographical locations. In one embodiment, the computing device 105 represents a virtualized computer system executing on one or more physical computing systems. For purposes of convenience, the computing devices 105 are referred to herein in the singular. Even though the term “computing device” is referred to in the singular, it is understood that a plurality of computing devices 105 may be employed in the various arrangements as described above. An exemplary computing device would include one or more processors, storage, memory (e.g., RAM and flash or disk storage) for a data store and applications including an electronic list application, a data store search engine and various support engines described herein and shown, for example, in FIG. 3. The software engines described herein may be implemented across hardware platforms. One or more high speed data bus(es) or similar subsystem transfers data from one component to another. This can include transferring data to and from the memory, or from one or more processing units to other components. Additional aspects of the cloud based infrastructure are detailed below.

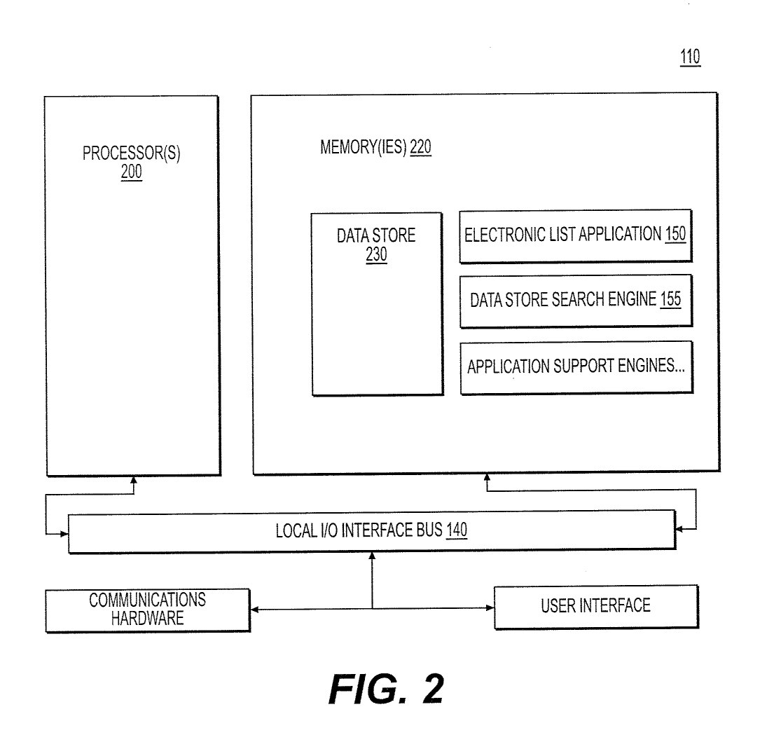

An exemplary network device 110 is shown in FIG. 2, including one or more processors 220, and memory (e.g., RAM and flash or disk storage) for a data store 230 and applications including an electronic list application 150, a data store search engine 155 and various support engines described herein. One or more high speed data bus(es) 140 or similar subsystem transfers data from one component to another. This can include transferring data to and from the memory, or from one or more processing units 200 to other components. The network devices 110 also include communication equipment such as (but not limited to) digital cellular communication equipment, wireless communication equipment for 3G and/or 4G IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces, Bluetooth and/or infra data association (IrDA) modules for wireless Bluetooth or wireless infrared communications. However, the present invention is not limited to such an embodiment and other 802.11xx and other types of wireless interfaces can also be used.

As shown in FIG. 3, the data stored in the data store 130 includes, for example, USER PROFILES 131, USER LISTS 132, USER DATA RECORDS 133 each of which stores information about users of an electronic list system implemented by the electronic list application 150. USER DATA records may contain additional data about the user, such as a geographic location history, product interests, purchase history data, past user lists, past routes, data that tracks the interaction of users with an electronic list system and/or the electronic list application 150 (e.g., indicating how a user has navigated through the electronic list system and the products or communities in which a user has viewed and/or expressed an interest). Importantly, the USER PROFILE records 131 are stored separately from the USER LISTS 132 to preserve anonymity of USER PROFILE records to the extent desired. Other data stored in the DATA STORE 130 may include GROUP RECORDS 134, VENDOR PROFILES 135, VENDOR RECORDS 136 or the like (based on the applications to be implemented).

The components executed on the computing device 105, for example, include an electronic list application 150, a data store search engine 155, a synchronization engine 160, a polling engine 165, deduplication engine 170, an affiliate group list generation engine 171, a recommendation engine 172, a location engine 173, a purchase allocation engine 174, an inventory query engine 175, an incentive engine 176, an image recognition engine 177, an encryption engine 178, a biometric data engine 179, list exchange engine, QR code generating engine, route planning engine, driver order and delivery engine [DODE], synchronization engine, communication engine and a payment engine 180.

The electronic list application 150 is executed to facilitate creation and synchronization of USER LISTS across user devices (represented generally by 110), encourage the creation of user generated lists and facilitate the sharing of list and user information in a cloud environment.

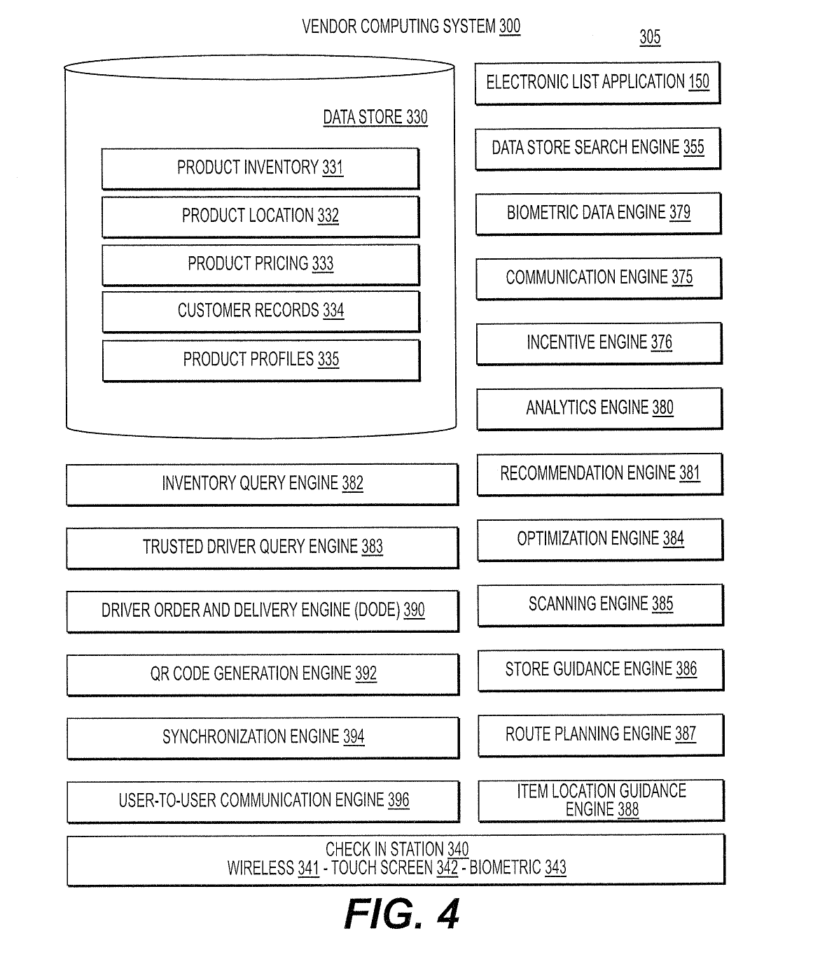

The system may interact with or even integrate with user systems such as the VENDOR computer system shown in FIG. 4. The system includes a computing device 305 that includes one or more processors 200, storage, memory 220 (e.g., RAM and flash or disk storage) for a data store 330 and applications including an electronic list application 150, a data store search engine 155 and various support engines. One or more high speed data bus(es) 140 or similar subsystem transfers data from one component to another. This can include transferring data to and from the memory, or from one or more processing units to other components.

As shown, the vendor data store 330 may include data records of product inventory 331, product location 332, product pricing 333, customer records 334 and product profiles 335. The vendor system 300 further includes a “check-in” station 340 that allows the VENDOR system to recognize (identify) a USER of the electronic list system. The a “check-in” station 340 may include various hardware and software including wireless web-enabled “check in” application hardware and software 341, a card swipe, RFID reader, a USER touch screen “check in” interface 342 and a biometric “check in” interface 343.

The components executed on the computing device 105 or 305, for example, include an electronic list application 150, a data store search engine 355, a biometric data engine 379, communication engine 375 for facilitating communication with the electronic list system, an incentive engine 376, list exchange engine, QR code generating engine 392, scanning engine 385, store guidance engine 386, route planning engine 387, driver order and delivery engine [DODE] 390, item location guidance engine 388, synchronization engine 394, peer-to-peer user communication engine 396 and an analytics engine 380. The software engines depicted may also be installed and executed on the system operator's system depicted in FIG. 3, as appropriate or across platforms. For example, the QR code generating engine, route planning engine, driver order and delivery engine [DODE], synchronization engine and peer-to peer communication engine are suited to use on the system operator's cloud based infrastructure.

The client or user device 110 (aka network device) is a device that allows the USER to access the network. It is contemplated that individual users may interact with the system using more than one distinct client or network device, non-limiting examples of which are shown in FIG. 1 as 110a (a vehicle telematics system), 110b (smart phones), 110c (a tablet) and 110d (a computer). The system includes a synchronization engine 160 to ensure that the USER LISTS are synchronized across all devices associated with a particular USER ID. USER LISTS are stored in the cloud, but local copies may be stored on the client devices 110. As used herein, network devices include, but are not limited to, multimedia capable desktop and laptop computers, tablet computers, facsimile machines, mobile phones, non-mobile phones, smart phones, Internet phones, vehicle built-in and beam-in systems, Internet appliances, personal digital/data assistants (PDA), two-way pagers, digital cameras, portable game consoles (Play Station Portable by Sony, Game Boy by Sony, Nintendo DSI, etc.), non-portable game consoles (Xbox by Microsoft, Play Station by Sony, Wii by Nintendo, etc.), cable television (CATV) set-top boxes, digital televisions including high definition television (HDTV), three-dimensional (3D) televisions and other types of network devices.

The client 110 may be a vehicle telematics device (e.g., 110a) integrated into or otherwise on board an automobile or other vehicle. As used herein, vehicle telematics refers to the convergence of telecommunications and information processing used to facilitate automation in automobiles, such as GPS navigation, integrated hands-free cell phones, wireless safety communications and automatic driving assistance systems. An example of a standard that addresses and enhances Intelligent Transportation System is 802.11p, the IEEE standard in the 802.11 family and also referred to as Wireless Access for the Vehicular Environment (WAVE). Telematics are useful in the collection, aggregation, and storage of pertinent data that can be digested locally, or post-processed remotely. Telematics systems typically include GPS based location detection services and can also receive and display information on traffic congestion and suggest alternate routes. These may use either TMC, which delivers coded traffic information using radio RDS, or by GPRS/3G data transmission via mobile phones. Traffic information may also include real-time data about free/full parking facilities; nearest public transport lines and prices, to go to a destination, when there is a jam. Weather related information is also available. While variants on these services are often available using smart phones, the telematics systems may be superior and have the advantage of always being on board the vehicle. Telematics systems may include celluar communication equipment or integrate (or communicate) with mobile phones for hands-free talking and SMS messaging (i.e., using Bluetooth or Wi-Fi). Automotive navigation systems can include personal information management for meetings, which can be combined with a traffic and public transport information system. The telematics system may also include or integrate with an event data recorder or EDR installed in the vehicle to record information related to vehicle events. The EDR may be a simple, tamper-proof, read-write memory device, similar to the “black box” found on airplanes or a more sophisticated system for recording a vehicle history. Some EDRs continuously record data, overwriting the previous few minutes until a crash stops them, and others are activated by crash-like events (such as sudden changes in velocity) and may continue to record until the accident is over, or until the recording time is expired. EDRs may record a wide range of data elements, potentially including whether the brakes were applied, the speed at the time of impact, the steering angle, and whether seat belt circuits were shown as “Buckled” or “Unbuckled” at the time of the crash. Current EDRs store the information internally on an EEPROM until recovered from the module. Some vehicles have communications systems (such as GM's OnStar system) that may transmit some data, such as an alert that the airbags have been deployed, to a remote location.

There are two basic approaches to telematics systems: built-in or beamed-in. Built-in systems I use proprietary hardware within the car, while beamed-in systems like are essentially elaborate smartphone interfaces. Built-in systems typically offer better integration and reliability, but they cost more to develop and could become obsolete. Beamed-in systems minimize hardware costs and the risk of obsolescence. Built-in systems may be updated by adding a new chipset module. A/hybrid approach uses a built-in system for “mission critical” features like safety, and beamed-in system for features like entertainment. APPS can also let you control your car remotely—lock your doors, schedule service calls and, in the case of electric vehicles, monitor how much juice is in the battery and decide when your electric vehicle starts drawing power from the socket once you've plugged it in. Interfaces include voice activation, gesture recognition and other features the system may use radar, speed sensors and other tech to allow greater use of infotainment features in light traffic while sharply curtailing functionality in adverse conditions.

The client 110 may comprise, for example, a processor-based system such as a computer system (e.g., 110c,d). Such a computer system may be embodied in the form of a desktop computer, a laptop computer, a personal digital assistant, a cellular telephone, set-top box, music players, web pads, tablet computer systems, or other devices with like capability.

A “smart phone” is a mobile phone (110b) that offers more advanced computing ability and connectivity than a contemporary basic feature phone. Smart phones and feature phones may be thought of as handheld computers integrated with a mobile telephone, but while most feature phones are able to run applications based on platforms such as Java ME, a smart phone usually allows the user to install and run more advanced applications. Smart phones and/or tablet computers run complete operating system software providing a platform for application developers. Examples of smart phones such as the iPhone by Apple, Inc., Blackberry Storm and other Blackberry models by Research In Motion, Inc. (RIM), Droid by Motorola, Inc. HTC, Inc. other types of smart phones, etc. However, the present invention is not limited to such smart phone devices, and more, fewer or other devices can be used to practice the invention. Smart network devices include tablet computers such as the iPad, by Apple, Inc., Galaxy by Samsung, the HP Tablet, by Hewlett Packard, Inc., Kindle by Amazon, Nook by Barnes & Noble, the Playbook, by RIM, Inc., the Tablet, by Sony, Inc. The operating systems include the iPhone OS, Apple OS, Android, Windows, etc. iPhone OS is a proprietary operating system for the Apple iPhone. Andriod is an open source operating system platform backed by Google, along with major hardware and software developers (such as Intel, HTC, ARM, Motorola and Samsung, etc.), that form the Open Handset Alliance.

The target network devices 110 are in communication with a cloud communications network 120 via one or more wired and/or wireless communications interfaces. The cloud communications network 120 includes, but is not limited to, communications over a wire connected to the target network devices, wireless communications, and other types of communications using one or more communications and/or networking protocols.

Plural server network devices each with one or more processors and a computer readable medium include one or more associated databases. The plural network devices are in communication with the one or more target devices via the cloud communications network 120. The plural server network devices include, but are not limited to, World Wide Web servers, Internet servers, search engine servers, vertical search engine servers, social networking site servers, file servers, other types of electronic information servers, and other types of server network devices (e.g., edge servers, firewalls, routers, gateways, etc.). The plural server network devices also include, but are not limited to, network servers used for cloud computing providers, etc.

The cloud communications network 120 includes, but is not limited to, a wired and/or wireless communications network comprising: the Internet, an intranet, a Local Area Network (LAN), a LAN (WiLAN), a Wide Area Network (WAN), a Metropolitan Area Network (MAN), a Public Switched Telephone Network (PSTN), a cloud communications network 26 and other types of wired and/or wireless communications networks 18.

The cloud communications network 120 may include one or more gateways, routers, bridges and/or switches As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another. A switch is a device that filters and forwards packets between network segments based on some pre-determined sequence (e.g., timing, sequence number, etc.)

As shown in FIG. 2, an operating environment for the network devices 110 of the electronic list system include a processing system with one or more high speed Central Processing Unit(s) (CPU), processors 200, one or more memories 220 and/or other types of computer readable mediums. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical information by the CPU or processor 200. An electrical system represents data bits that cause a resulting transformation or reduction of the electrical information or biological information, and the maintenance of data bits at memory locations in a memory system to thereby reconfigure or otherwise alter the CPU's or processor's operation, as well as other processing of information. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (RAM)) or non-volatile (e.g., Read-Only Memory (ROM), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

The client 110 may be configured to execute the various applications described herein (e.g., electronic list application 150) and other applications such as a web browser. The browser may be executed in a client 110, for example, to access and render network pages, such as web pages, or other network content served up by the computing device 105 and/or other servers. The client 110 may be configured to execute applications beyond the browser 141 such as, for example, email applications, instant message applications, social networking applications, and/or other applications. The client 110 can also include additional special purpose hardware and software components with which a browser 141 or other software executed on the client 110 may interact.

As one non-limiting example, the client 110 may comprise a mobile device including cellular telephone, location detection hardware, and software components. Accordingly, the mobile device client 110a can detect the location of a user using the client 110, which can be incorporated into various location based services and applications executed thereon. In one embodiment, the user can utilize location based services and applications executed on a client 110 to provide location based features and/or services in the context of this disclosure. The client 110 can also include a special purpose application tailored to interact with the electronic list application 150. As one example, the client 110 can comprise a mobile device with a dedicated application configured to allow a user to interact with the electronic list application 150 with client side code that enhances a user experience by providing more complex user interface elements and other functionality.

Next, a general description that provides one example of the operation of the various components of the networked environment 100 is provided. The electronic list application 150 can allow a user on a client 110 to view

FIG. 2 shows is a schematic block diagram of the computing device 105 (FIG. 1) according to an embodiment of the present disclosure. The computing device 105 includes at least one processor circuit, for example, having a processor 200 and a memory 220, both of which are coupled to a local interface 140. To this end, the computing device 105 may comprise, for example, at least one server computer or like device. The local interface 140 may comprise, for example, a data bus with an accompanying address/control bus or other bus structure as can be appreciated. The computing device interacts with a user interface which may be embodied as a touchscreen or other display with input.

Stored in the memory 220 are both data and several components that are executable by the processor 200. In particular, stored in the memory 220 and executable by the processor 200 are an electronic list application 150 (FIG. 1), recommendation engine 172, location engine 173, purchase allocation engine 174, inventory query engine 175, an incentive engine 176, image recognition engine 177 and encryption engine 178 (and, optionally, other engines described herein). In addition, an operating system may be stored in the memory 220 and executable by the processor 200.

It is understood that there may be other applications that are stored in the memory 220 and are executable by the processors 200 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components including engines are stored in the memory 220 and are executable by the processor 200. In this respect, the term “executable” means a program file that is in a form that can ultimately be run by the processor 200. Examples of executable programs may be, for example, a compiled program that can be translated into machine code in a format that can be loaded into a random access portion of the memory 220 and run by the processor 200, source code that may be expressed in proper format such as object code that is capable of being loaded into a random access portion of the memory 220 and executed by the processor 200, or source code that may be interpreted by another executable program to generate instructions in a random access portion of the memory 220 to be executed by the processor 200, etc. An executable program may be stored in any portion or component of the memory 220 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 220 is defined herein as including both volatile and nonvolatile memory and data storage components. Volatile components are those that do not retain data values upon loss of power. Nonvolatile components are those that retain data upon a loss of power. Thus, the memory 220 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 200 may represent multiple processors 200 and the memory 220 may represent multiple memories 220 that operate in parallel processing circuits, respectively. In such a case, the local interface 140 may be an appropriate network 120 (FIG. 1) that facilitates communication between any two of the multiple processors 200, between any processor 200 and any of the memories 220, or between any two of the memories 220, etc. The local interface 140 may comprise additional systems designed to coordinate this communication, including, for example, performing load balancing. The processor 200 may be of electrical or of some other available construction.

Although the electronic list application 150 (FIG. 1), recommendation engine 172, location engine 173, purchase allocation engine 174, inventory query engine 175, incentive engine 176, image recognition engine 177 and encryption engine 178 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The IMAGE RECONGITION ENGINE 177 uses available computer vision software to find and identify objects in an image or video sequence. There are many kinds of computer vision systems, nevertheless all of them contains these basic elements: power source, at least one image acquisition device (i.e. camera, ccd, etc), processor as well as control and communication cables or some kind of wireless interconnection mechanism. In addition a practical vision system contains software for application and develop as well as a display in order to monitor what does the system do. Google Goggles is a currently available example. Google Googles was developed for use on Google's Android operating systems for mobile devices. Currently the system can identify various labels or landmarks, allowing users to learn about such items without needing a text-based search. The system can identify products barcodes or labels that allow users to search for similar products and prices, and save codes for future reference. The system will also recognize printed text and use optical character recognition (OCR) to produce a text snippet. Although developed for Android there is now also an iPhone version

Any available computer vision hardware and software may be used to provide the IMAGE RECOGNITION ENGINE 177 functionality. There are, however, typical functions that are found in many computer vision systems.

Image acquisition—A digital image is produced by one or several image sensors, which, besides various types of light-sensitive cameras, include range sensors, tomography devices, radar, ultra-sonic cameras, etc. Depending on the type of sensor, the resulting image data is an ordinary 2D image, a 3D volume, or an image sequence. The pixel values typically correspond to light intensity in one or several spectral bands (gray images or colour images), but can also be related to various physical measures, such as depth, absorption or reflectance of sonic or electromagnetic waves, or nuclear magnetic resonance. Pre-processing—Before a computer vision method can be applied to image data in order to extract some specific piece of information, it is usually necessary to process the data in order to assure that it satisfies certain assumptions implied by the method. Examples are Re-sampling in order to assure that the image coordinate system is correct Noise reduction in order to assure that sensor noise does not introduce false information. Contrast enhancement to assure that relevant information can be detected. Scale space representation to enhance image structures at locally appropriate scales. Feature extraction—Image features at various levels of complexity are extracted from the image data. Typical examples of such features are Lines, edges and ridges. Localized interest points such as corners, blobs or points. More complex features may be related to texture, shape or motion.Detection/segmentation—At some point in the processing a decision is made about which image points or regions of the image are relevant for further processing. Examples are Selection of a specific set of interest points. Segmentation of one or multiple image regions that contain a specific object of interest. High-level processing—At this step the input is typically a small set of data, for example a set of points or an image region which is assumed to contain a specific object. The remaining processing deals with, for example: Verification that the data satisfy model-based and application specific assumptions; Estimation of application specific parameters, such as object pose or object size; Image recognition—classifying a detected object into different categories; Image registration—comparing and combining two different views of the same object. Decision making Making the final decision required for the application,[9] for example: Pass/fail on automatic inspection applications. Match/no-match in recognition applications Flag for further human review in medical, military, security and recognition applications

The system includes a DATA STORE SEARCH ENGINE 155 for searching data stored within the system including USER LISTS, USER PROFILES, and VENDOR PROFILES. The engine indexes data from the various source within the system and also use access controls to enforce a security policy.

The DATA STORE SEARCH ENGINE 155 may be implemented by software performing the following functions:

In an enterprise search systems, content goes through various phases from source repository to search results:

### Content Ingestion

Content ingestion (or “content collection”) may use a push or pull model. In the push model, a source system is integrated with the search engine in such a way that it connects to it and pushes new content directly to its APIs. This model is used when real time indexing is important. In the pull model, the software gathers content from sources using a connector such as a web crawler or a database connector. The connector typically polls the source with certain intervals to look for new, updated or deleted content.

### Content Processing and Analysis

If any content from different sources has different formats or document types, such as XML, HTML, Office document formats or plain text, the content processing phase processes the incoming documents to plain text using document filters. It may be necessary to normalize content in various ways to improve recall or precision. These may include stemming, lemmatization, synonym expansion, entity extraction, part of speech tagging.

As part of processing and analysis, tokenization is applied to split the content into tokens which is the basic matching unit. It is also common to normalize tokens to lower case to provide case-insensitive search, as well as to normalize accents to provide better recall.

### Indexing

The resulting text is stored in an index, which is optimized for quick lookups without storing the full text of the document. The index may contain the dictionary of all unique words in the corpus as well as information about ranking and term frequency.

### Query Parsing

When a user issues a query to the system, the query consists of any terms the user enters as well as navigational actions such as faceting and paging information.

### Matching

The processed query is then compared to the stored index, and the search system returns results (or “hits”) referencing source documents that match. Some systems are able to present the document as it was indexed.

The DEDUPLICATION ENGINE 170 is used when combining user lists to identify and purge undesired duplicate list items. In some contexts, it can be assumed that any duplicate list item is undesired and such items can be automatically purged. In other contexts, however, it is necessary to verify that a duplicate list item is, in fact, undesired. In the grocery list example, the first user ALEXIS might enter “toothbrush” and “paper towel” on her list. Another member of the same household group (e.g., Bella) might also enter “toothbrush” and “paper towel” on her list. When the household list is generated by combining the lists of all household members, the DEDUPLICATION ENGINE 170 will detect duplicate list items for “toothbrush” and “paper towel.” In this instance, however, the two users each want their own toothbrush (naturally), but are willing to share paper towel. To accommodate situations such as this, the DEDUPLICATION ENGINE 170 includes a “confirm duplicate” functionality that, when enabled, prompts a user to confirm the addition or deletion of duplicate list items. If the functionality is not enabled, duplicate items can be automatically purged or automatically saved in a computer readable medium depending on user preference.

The DEDUPLICATION ENGINE 170 preferably employs known “duplicate detection” techniques that may include several steps. First, data preprocessing to standardize data through simple rule-based data transformations or more complex procedures such as lexicon-based tokenization and probabilistic hidden Markov models. Next, identity resolution to connect disparate data sources with a view to understanding possible identity matches and non-obvious relationships across multiple data silos. Identity resolution analyzes all of the information relating to individuals and/or entities from multiple sources of data, and then applies likelihood and probability scoring to determine which identities are a match and what, if any, non-obvious relationships exist between those identities.

Deterministic record linkage, a more simple form of record linkage, deterministic or rules-based record linkage, generates links based on the number of individual identifiers that match among the available data sets. Two records are said to match via a deterministic record linkage procedure if all or some identifiers (above a certain threshold) are identical. Deterministic record linkage is a good option when the entities in the data sets are identified by a common identifier, or when there are several representative identifiers whose quality of data is relatively high. Probabilistic record linkage, sometimes called fuzzy matching (also probabilistic merging or fuzzy merging in the context of merging of databases), takes a different approach to the record linkage problem by taking into account a wider range of potential identifiers, computing weights for each identifier based on its estimated ability to correctly identify a match or a non-match, and using these weights to calculate the probability that two given records refer to the same entity. Record pairs with probabilities above a certain threshold are considered to be matches, while pairs with probabilities below another threshold are considered to be non-matches; pairs that fall between these two thresholds are considered to be “possible matches” and can be dealt with accordingly (e.g., human reviewed, linked, or not linked, depending on the requirements). Whereas deterministic record linkage requires a series of potentially complex rules to be programmed ahead of time, probabilistic record linkage methods can be “trained” to perform well with much less human intervention. Probabilistic record linkage algorithms may assign match/non-match weights to identifiers by means of u probabilities and m probabilities. The u probability is the probability that an identifier in two non-matching records will agree purely by chance.

### Incentive Engine

As noted, the system infrastructure allows users to create and share multiple lists that can then be used to facilitate commercial and other transactions. As is evident from this description, there are incentives for the USERS to create lists provided in the implementation of the APPS supported by this infrastructure including, for example, reduced cost, increased convenience and options for preserving anonymity to an increased extent. The INCENTIVE ENGINE 176 of the system can also be used to implement/supplement existing award or loyalty programs and to support development of entirely new incentive programs based on stored transaction and activity records. The system and method is preferably implemented by one or more computers programmed to execute engines and perform processes according to the present invention.

In one example, an incentive program may provide an individual USER redemption rate that may be calculated and stored separately for each participant in the incentive program. In this example, a two-component incentive program of the present invention may be considered as consisting of two distinct incentive programs operating in parallel. The first is a “Base Program,” which can be an existing (or modeled based on any) known “points” type incentive program. The second of the two programs is a “Variable Redemption Rate Program” under which the value of points accumulated under the first program (Base Program) can vary according to a distinct set of rules. Though these programs can be considered as distinct from one another, it is possible to structure the program so that the distinction is not evident to the participants.

Under the base program, each participant within the system has an identity, and an ability to participate in the Base Program (or existing award programs) so as to earn “points,” which can be referred to under other names, including miles, dollars, credits, etc. Points are awarded based upon rules that are widely applied across a wide class of participants. Thus for example, everyone flying the airline shuttle between Washington, D.C. and New York earns 1,000 miles for the flight regardless of whether the participant is a one-time user that had no choice but to take the flight or a weekly flyer whose continued patronage would be very valuable.

Most “frequent flyer” programs by their very nature reward frequent customers. In particular, the programs are cumulative so that awards accumulate over time. In some programs there are bonuses for passengers that travel a certain number of segments within a prescribed period. Conversely, many programs “expire” points after a certain period of time, without regard to the loyalty of the customer. All of these programs are ham handed ways of attempting to incentivize participant action with greater precision and create more intense participant loyalty.

In contrast, the addition of a variable redemption rate program component according to the present invention provides an incentive system and process that allows precise encouragement of specific participant action and makes it possible to create more intense participant loyalty. In an incentive system and process according to the present invention, participant earnings, whether miles, cash or points, are treated as base points (BP) that are multiplied by a customer specific redemption rate (R) to convert the base points into participant rewards.

The two component incentive program is multi-dimensional in several respects. First, the two completely distinct reward programs' components—the Base Program for earning points and the Variable Redemption Rate program for adjusting each participants individual redemption rate—are fundamentally distinct since the base awards program is cumulative whereas as the redemption rate program is transitory in that the redemption rate can be adjusted up or down very quickly (or slowly) depending on participant action or inaction. This introduces an opportunity to incentivize the timing of participant actions that is well beyond anything that can be done with conventional incentive programs. Though the reward program components are distinct from one another, both components can apply to the same participant action so as to enhance or dampen the incentives in a single program. Since each program component can affect the value of rewards offered by the other program component, there is an opportunity to achieve tremendous synergism by optimizing participant action.

As an example, consider that a loyal customer in a conventional program is likely to have accumulated many “points” in that program. Now consider the incentive that would be created by the possibility of increasing the redemption value of all of these accumulated points by 50% or even 100%. The combined results of the two programs thus offer the ability to provide the greatest incentive to the most important (profitable) participants.

The ease of quickly reducing a participant's redemption rate can be used to reward participant actions such as brand loyalty, profitability, consistency and frequency of use, that are desirable from a sponsor's vantage point. The variable redemption rate can also be used for special promotions or to compensate participants for poor performance by the sponsor. As one example, the variable redemption rate can be used to gain and maintain participant loyalty by rewarding consistency with incremental increases and discouraging lapses in loyalty through punitive decreases in redemption rate. Moreover, when used in conjunction with technology, such as a smart card that allows the program administrator to monitor the participant's actions more closely, it is possible to structure a program that creates a disincentive (such as a reduction in redemption rate) for shopping at a competitor's store or buying a competitor's product. Other applications, some of which are described below, will be apparent to those skilled in the art.

The present invention is applicable to existing reward programs such as airline reward programs, credit card reward programs, point of purchase reward, internet loyalty reward programs and like. Base points (BP) can be any form of accumulated reward, including for example airline miles, cash awards, points, accumulated winnings, accumulated losses, etc. As applied by the INCENTIVE ENGINE 176 described herein, the generation and sharing of USER lists could be tracked and used to increase a USER's variable redemption rate. In contrast, lack a activity in the system could be used to reduce a USER's variable redemption rate. In addition or alternatively, to encourage users to “check in” with participating vendors users could be awarded points, rebates or discounts for checking in. Likewise, users who purchase items from participating vendors that targeted them through the system could be awarded points, rebates or discounts.

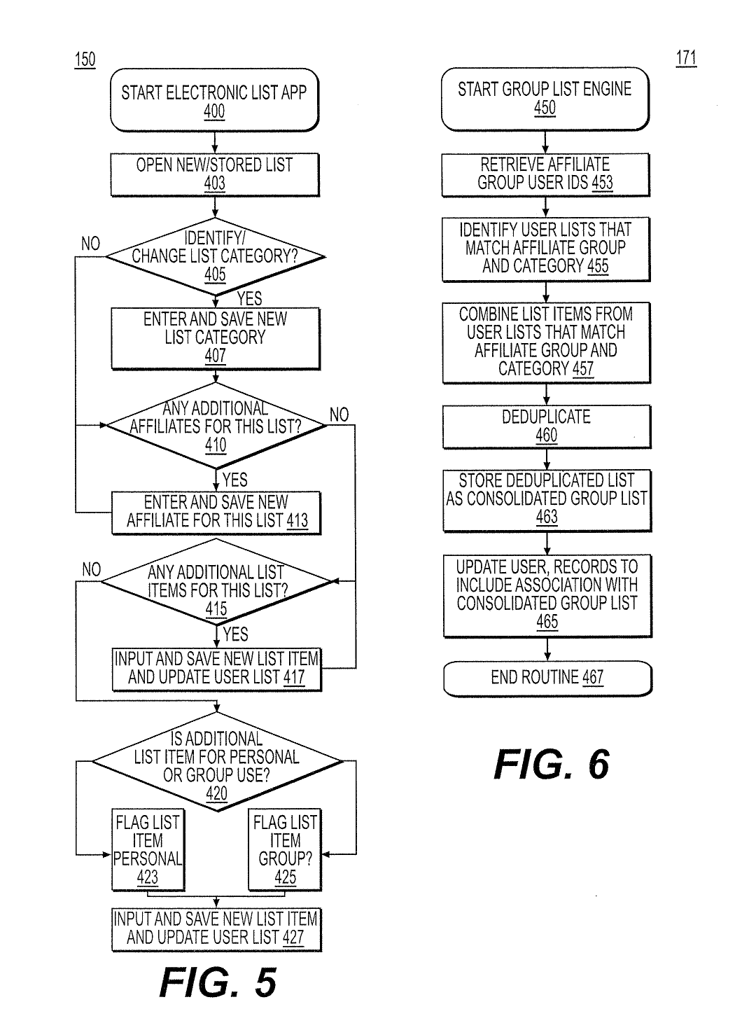

The flowcharts of FIGS. 5-15 show the functionality and operation of an implementation of portions of the electronic list application 150 (FIG. 1), recommendation engine 172, location engine 173, purchase allocation engine 174, inventory query engine 175, incentive engine 176, image recognition engine 177, encryption engine 178, a trusted driver query engine 383 supporting a distributed distribution process; an optimization engine 184; a logistics engine 185 and a distributed driver order and delivery engine 390.

If embodied in software, each block may represent a module, segment, or portion of code that comprises program instructions to implement the specified logical function(s) on one or more hardware platforms or across platforms. The program instructions may be embodied in the form of source code that comprises human-readable statements written in a programming language or machine code that comprises numerical instructions recognizable by a suitable execution system such as a processor 200 in a computer system or other system. The machine code may be converted from the source code, etc. If embodied in hardware, each block may represent a circuit or a number of interconnected circuits to implement the specified logical function(s).

Although the flowcharts of FIG. 5-14 show a specific order of execution, it is understood that the order of execution may differ from that which is depicted. For example, the order of execution of two or more blocks may be scrambled relative to the order shown. Also, two or more blocks shown in succession in FIGS. 5-14 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the electronic list application 150 (FIG. 1), recommendation engine 172, location engine 173, purchase allocation engine 174, inventory query engine 175, incentive engine 176, image recognition engine 177; encryption engine 178; polling engine 165; payment engine 180; trusted driver query engine 183; optimization engine 184, logistics engine 185 and driver order and delivery system 390 that comprises software or code can be embodied in any non-transitory computer-readable medium for use by or in connection with an instruction execution system such as, for example, a processor 200 in a computer system or other system. In this sense, the logic may comprise, for example, statements including instructions and declarations that can be fetched from the computer-readable medium and executed by the instruction execution system.

In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The following discussion now refers to processes or methods and steps that may be performed by the system. Those skilled in the art will understand that these steps may be implemented in and across various hardware configurations including a general purpose networked computing system configures to execute software instructions. As used in this application, “software engine” or “engine” are used to refer to the core of a computer program that drive the functionality of the program as opposed to peripheral aspects of the program, such as look and feel. Those skilled in the art understand terms as shorthand referring to library, platform, SDK or object associated with an encapsulated block of functionality beyond a mere module. A software engine can start and stop and run idle for periods of time. Examples of software engines include relational database engines, workflow engines, and search engines. A common characteristic of software engines is metadata that provides models of the real data that the engine processes. Software modules pass data to the engine, and the engine uses its metadata models to transform the data into a different state. The steps (method acts) may be discussed in a certain order or illustrated in a flow chart as occurring in a particular order, but no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, SSD, CD-ROM or other optical disk storage, magnetic disk storage or other magnetic storage devices, or any other medium that can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry data or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data that cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, cloud configurations, smart devices, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks (e.g. cloud computing, cloud services and the like). In a distributed system environment, program modules may be located in both local and remote memory storage devices.

For simplicity, the description of process flow will refer to the system as performing acts such as “system determine,” “system storing,” “system retrieving,” and “system verifying.” These acts are implemented using the hardware and software described herein.

FIG. 5 shows details of an exemplary electronic list application 150 process. At step 400, the electronic list APP begins and a new or stored list is opened at step 403. At step 405, the user is given an option to identify or change the category associated with the list. Identifying a category is optional, but if the user chooses to identify a category or change an existing category, the category is entered and saved in a computer readable medium at step 407. In the example of the “grocery list,” the category listed would be “groceries,” for example. At step 410, the user is given an option to add or change the list of affiliates associated with the list. Identifying one or more affiliates is optional, but if the user chooses to identify an affiliate or change (add or delete) an existing affiliate list, the new information is entered and saved in a computer readable medium at step 413. In the example of the “grocery list,” the affiliates listed would be household members, for example. At steps 415 and 417, a loop is executed to allow the user to enter item after item until there are non-additional items to be added to the list. For each additional list item, the user is prompted (at step 420) to indicate whether the additional list item is for personal or group use. Naturally this step could be omitted if there are no affiliates associated with the list. If the additional list item is personal (e.g., a toothbrush), the list item is flagged as personal at step 423. If the additional list item is for group use (e.g., paper towels), the list item is flagged as GROUP at step 425. Flagging the items as personal or group items is useful in deduplication of the list. The updated list is then saved in a computer readable medium at step 427.

FIG. 6 is a flow diagram detailing an exemplary GROUP LIST ENGINE process. The Group List Engine combines and deduplicates the lists of individual members of an affiliate group (e.g., household members) with respect to a particular category (e.g., Groceries). As shown, at step 450 the process begins and the group list engine of the system retrieves the USER IDs of the group members at step 453. At step 455, the group list engine of the system identifies USER lists that match both affiliate group and category. At step 457, lists that match both affiliate group and category are combined by the group list engine to create a “consolidated group list” that is then deduplicated (at step 460) to remove unintended duplicate list items. In the example of the household grocery list, duplicate list items that are flagged as personal (e.g., multiple toothbrushes) would be deemed by the group list engine as intended duplicates whereas duplicate list items that are flagged as GROUP (e.g., paper towels) would be deemed by the group list engine as unintended duplicates. At step 463, the deduplicated consolidated group list is stored in a computer readable medium by the group list engine and then, at step 465, the USER records are updated by the group list engine to include a link to the consolidated group list. The Group List Engine routine ends at step 467.

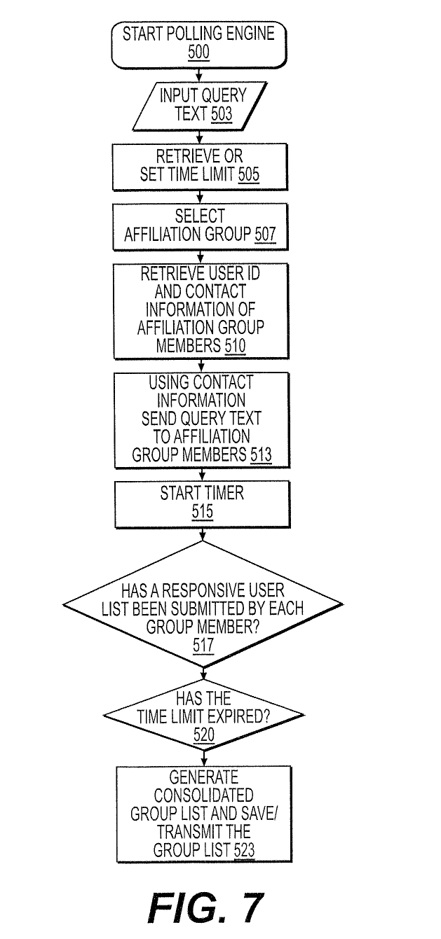

FIG. 7 is a flow diagram detailing an exemplary POLLING ENGINE process. At step 500 the polling engine is initiated and the user inputs the Query Text at step 503 that prompts users to create a list in response. The responsive list could be a single item response. The query text can be in a free format or a specified format and the query text may request responses in an open format or specified format. Thus, for example, one Query Text might be “I'm going to the grocery store, please send your list” with users free to create a list of items in the Grocery category. Another Query Text might be “Which candidates do you prefer?” with no requirement as to response format or length of the list response. Alternatively, the same query text might require a selection among a list of candidates. Another Query Text might be “Are you available to pick-up at Store #97 with delivery to 6311 Berkshire Drive?” and the response would be constrained to include a TRUSTED DRIVER ID and cost estimate. Yet another Query Text might be in a specified format, e.g., “INVENTORY CHECK: PRODUCT UPC 7618300017” and the required response would be constrained to include a Store ID and price.

Next, at step 505, the polling engine of the system retrieves a time limit for response either by reading a predetermined time limit stored in a computer readable medium or, alternatively, prompting the user to input a time limit for response. At step 507, the polling engine of the system retrieves a selection of one or more affiliation group(s) that is/are to receive that Query Text (again either by retrieving a preset group stored in a computer readable medium and/or prompting the USER to select a group or users). At step 510, the polling engine of the system retrieves the USER ID and contact information of the members of the selected affiliation group(s). At step 513, the Query Text is sent by the polling engine to the selected affiliation group members using the contact information retrieved at step 510. At steps 515, 517, 520 a timing sub-routine is executed by the polling engine to end the “polling” after either all group members have submitted a responsive list or the set time has expired. When the polling ends, the polling engine of the system generates a consolidated GROUP LIST that is saved in a computer readable medium and/or transmitted by the polling engine.

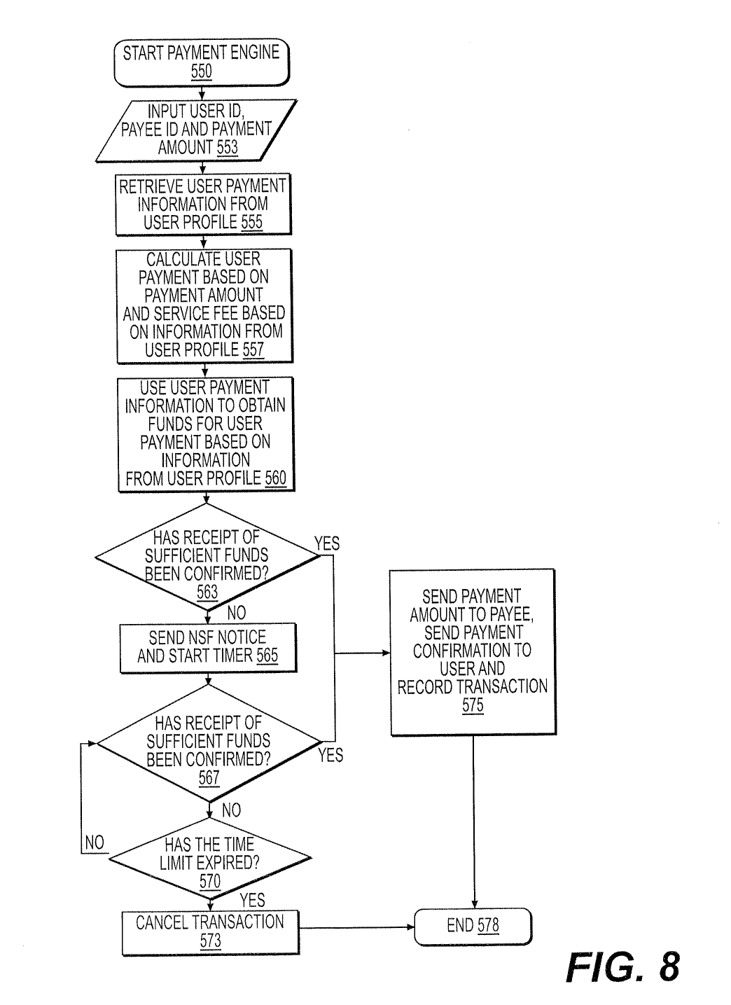

FIG. 8 is a flow diagram detailing an exemplary payment engine process. At step 550, the payment engine is initiated and at step 53, the USER ID, PAYEE ID and PAYMENT Amount are input into the payment engine. At step 555, the payment engine of the system retrieves user payment information from the USER PROFILE. The USER payment information could be bank information, a stored monetary value stored in a computer readable medium locally or credit card information or a proprietary account maintained within the system. The system can also use a consensus network, such as Bitcoin, that enables a payment system and completely digital money. Such a decentralized peer-to-peer payment network is powered by its users with no central authority or middlemen. From a user perspective, Bitcoin is seen as cash for the Internet, but Bitcoin can also be seen as a secure triple entry bookkeeping system. Bitcoin is the first implementation of “crypto-currency,” a form of money that uses cryptography to control its creation and transactions, rather than a central authority. The Bitcoin protocol and software are published openly and any developer can review the code or make their own modified version of the Bitcoin software. Bitcoin is controlled by all Bitcoin users around the world. While developers are improving the software, they can't force a change in the Bitcoin protocol because all users are free to choose what software and version they use. To stay compatible with each other, all users need to use software complying with the same rules. Bitcoin can only work correctly with a complete consensus among all users. Therefore, all users and developers have a strong incentive to protect this consensus.

From a user perspective, Bitcoin is a mobile app or computer program that provides a personal Bitcoin wallet and allows a user to send and receive bitcoins with them. Behind the scenes, the Bitcoin network is sharing a public ledger called the “block chain”. This ledger contains every transaction ever processed, allowing a user's computer to verify the validity of each transaction. The authenticity of each transaction is protected by digital signatures corresponding to the sending addresses, allowing all users to have full control over sending bitcoins from their own Bitcoin addresses. In addition, anyone can process transactions using the computing power of specialized hardware and earn a reward in bitcoins for this service. This is often called “mining.” More specifically, once a user installs a Bitcoin wallet on their computer or mobile phone, they receive a Bitcoin address and can create more whenever needed. The user can disclose their addresses to others so that they can the user or vice versa—similar to how email works, except that Bitcoin addresses should only be used once. The Balances block chain is a shared public ledger on which the entire Bitcoin network relies. All confirmed transactions are included in the block chain. In this way, Bitcoin wallets can calculate their spendable balance and new transactions can be verified to be spending bitcoins that are actually owned by the spender. The integrity and the chronological order of the block chain are enforced with cryptography. A transaction is a transfer of value between Bitcoin wallets that gets included in the block chain. Bitcoin wallets keep a secret piece of data called a private key or seed, which is used to sign transactions, providing a mathematical proof that they have come from the owner of the wallet. The signature also prevents the transaction from being altered by anybody once it has been issued. All transactions are broadcast between users and usually begin to be confirmed by the network in the following 10 minutes, through a process called mining. Mining is a distributed consensus system that is used to confirm waiting transactions by including them in the block chain. It enforces a chronological order in the block chain, protects the neutrality of the network, and allows different computers to agree on the state of the system. To be confirmed, transactions must be packed in a block that fits very strict cryptographic rules that will be verified by the network. These rules prevent previous blocks from being modified because doing so would invalidate all following blocks. Mining also creates the equivalent of a competitive lottery that prevents any individual from easily adding new blocks consecutively in the block chain. This way, no individuals can control what is included in the block chain or replace parts of the block chain to roll back their own spends.

Regardless of the form of payment, at step 557, the payment engine of the system calculates user payments based on payment amount and service fee based on the information obtained from the user profile. At step 560, the payment engine of the system attempts to obtain the funds needed for the user payment using the user payment information previously obtained. At step 563 the payment engine of the system checks to see if sufficient funds have been received. If Yes, at step 575, the payment engine of the system sends (transfers) the payment amount to the PAYEE and the credits the service fee (if any) to the service provider (which may be the SYSOP) and the process ends at step 578. If, on the other hand, the payment engine of the system determines (at step 567) that sufficient funds have NOT been received, the payment engine of the system continues to check until the time limit for making funds available has expired and once the time limit has expired the transaction is cancelled (step 570) by the payment engine and the process ends at step 578. Though not shown, the payment engine of the system could issue insufficient funds notifications and allow adjustment of the time limit and could also notify the USER that the transaction has been cancelled due to lack of sufficient funds.

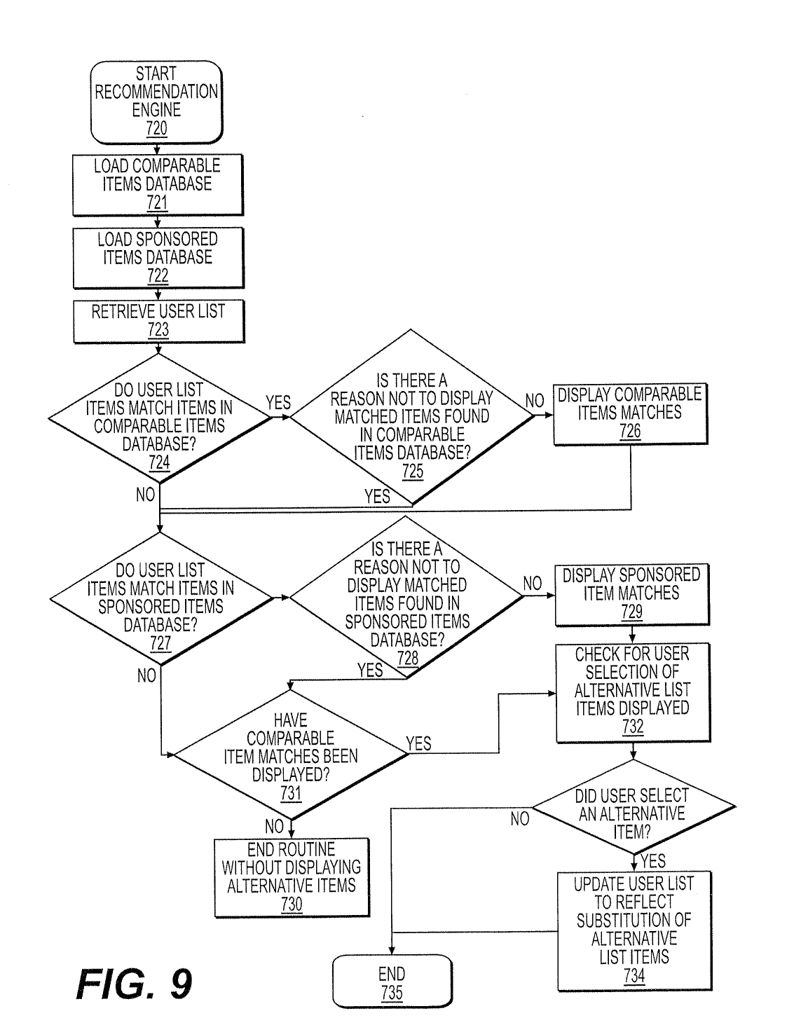

FIG. 9 is a flow diagram detailing an exemplary recommendation engine process. As shown, the process begins at step 720 when the recommendation engine is initiated. At step 721, the comparable items database is loaded into memory by the recommendation engine and at step 722 the sponsored items database is loaded by the recommendation engine. At step 723, the recommendation engine of the system retrieves the user list. At step 724, a determination is made as to whether the user list items match items in the comparable items database. If yes, then, at step 725, the recommendation engine makes a determination (based on stored preference information) as to whether there is a reason not to display matched items found in the comparable items database. For example, if the matched items would be competitive with a sponsored product, the vendor, for business reasons, may not want to display a comparable item. In any event, the recommendation engine of the system provides the option of further control of what offers are made to the consumer and if it is determined that there is no reason not to display the matched items found in the comparable items database. Then at step 726, the recommendation engine of the system displays comparable item matches. Next, at step 727, a determination is made by the recommendation engine as to whether user list items match sponsored items. If so, at step 728, the recommendation engine further determines (based on stored preference information) whether there is a reason not to display matched items found in the sponsored items database. If no, then the recommendation engine instructs a display to display sponsored item matches at step 729. At step 732, the recommendation engine of the system checks for user selection of alternative list items displayed. If the user selected an alternative item, at 733, the recommendation engine df the system updates the user list (step 734) to reflect substitution of the alternative list items. If the user did not select an alternative item, then at step 733, the recommendation engine of the system moves to the end of the program at step 735. At step 727, if the recommendation engine of the system determines that the user list items do not match sponsored items in the sponsored items database, the process moves to step 731 to determine whether comparable items have been displayed. If not, the recommendation engine of the system proceeds to step 730, which ends the routine without displaying alternative items. If, at step 731, it is determined that comparable item matches have been displayed, the recommendation engine of the system proceeds to step 732 described above.

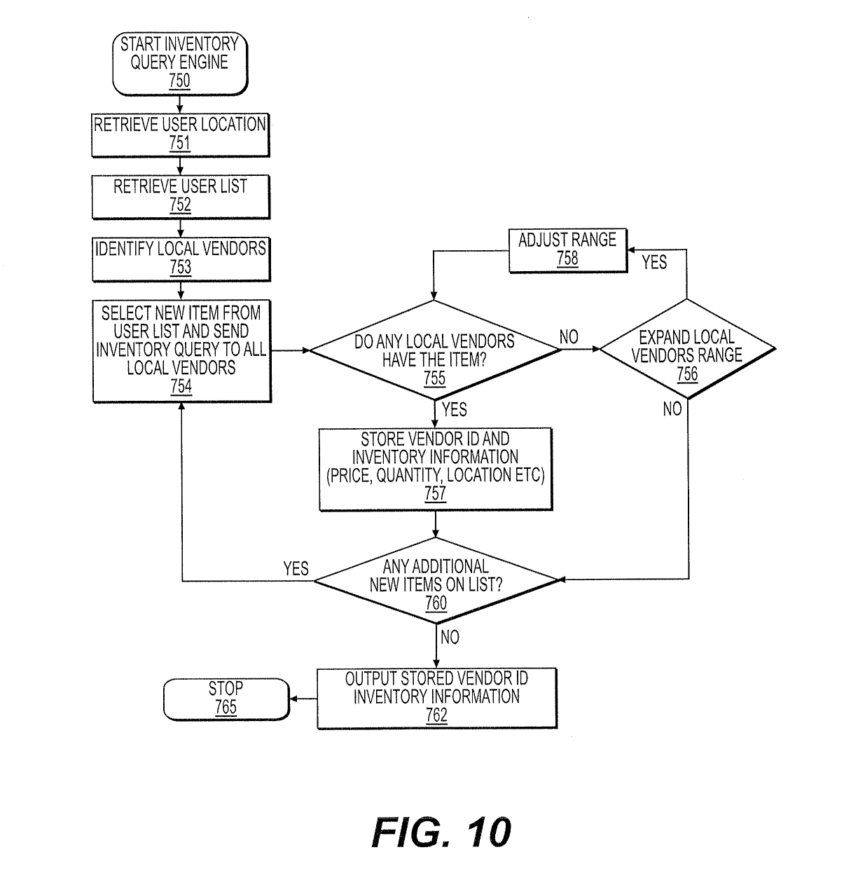

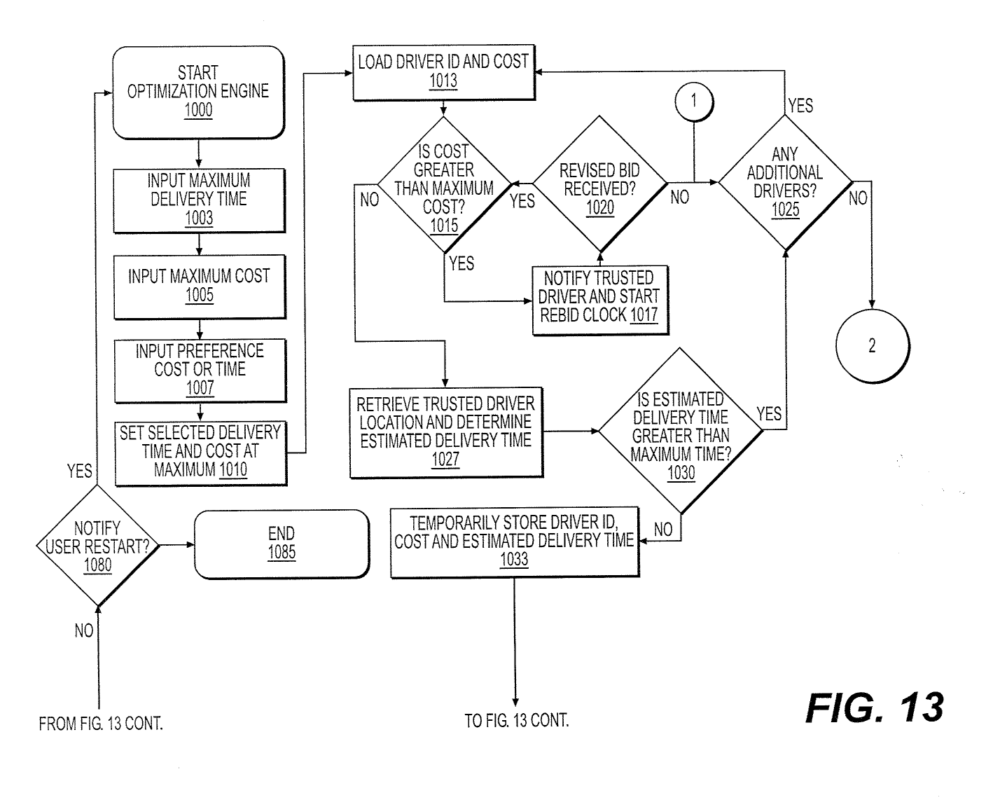

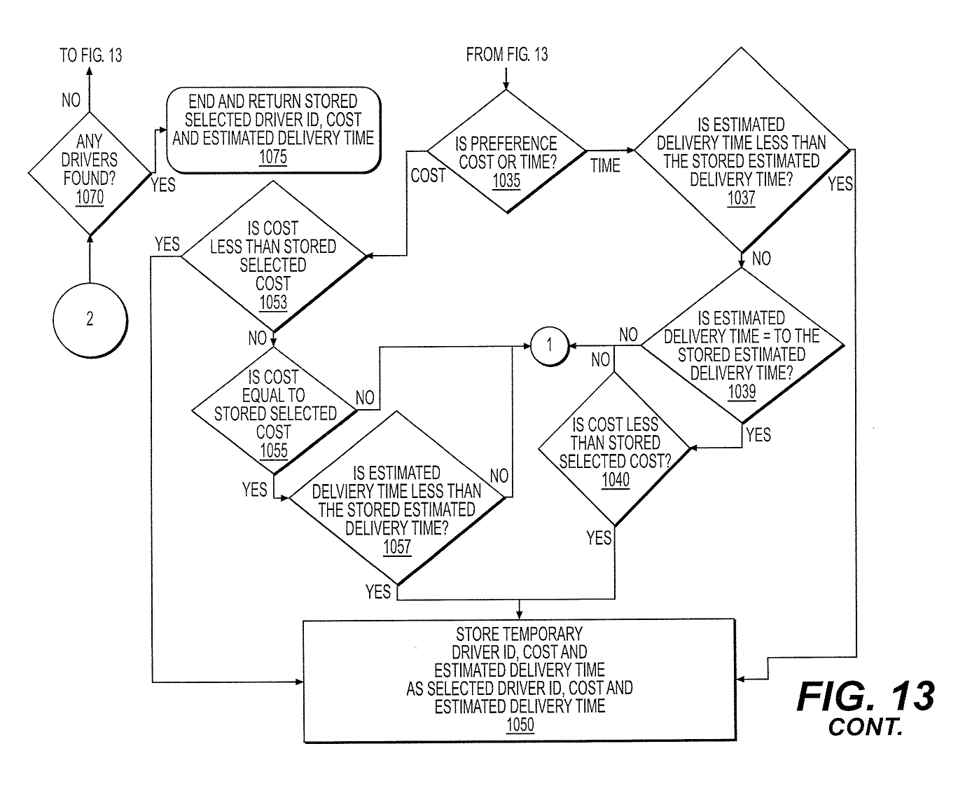

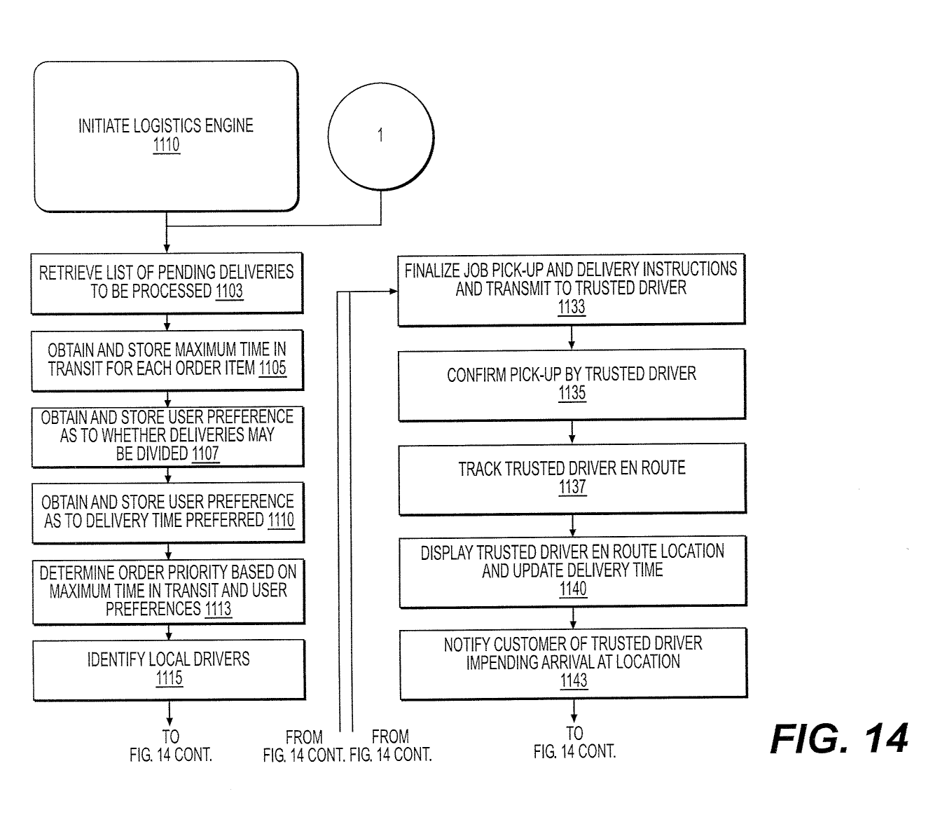

FIG. 10 is a flow diagram detailing an exemplary inventory query engine process. As shown, the inventory query engine is initiated at step 750. At step 751, the inventory query engine of the system retrieves the user location. The user location may be stored in a computer readable medium or it may be dynamically determined using the location position determining system of the type described herein. At step 752, the inventory query engine of the system retrieves the user list and at step 753, the inventory query engine of the system identifies local vendors. As used here, a “local vendor” is a vendor located with a predetermined range (distance or time) of the user. At step 754, an item is selected from the user list and the inventory query engine of the system sends an inventory query to all local vendors. At step 755 a determination is made as to whether any local vendors have the item. If no, the inventory query engine gives the user an option to expand the local vendor range at step 756. In other words, the definition of local can be expanded so that vendors within a greater distance (or travel time) will be considered local. If the user chooses to expand the local vendors range at step 756, the range is adjusted at step 758 and the process returns to step 755. If the inventory query engine of the system determines that one of more local vendors have the item, then at step 757, for each such local vendor, the inventory query engine of the system stores the vendor ID and inventory information including, for example, price, quantity, location etc. Next, at step 760, the inventory query engine of the system determines whether there are additional items on the list to be processed. If so, the process is repeated beginning at step 754. If not, this instance of the inventory query engine is complete, and at step 762 the inventory query engine of the system outputs stored vendor ID and inventory information and the inventory query engine of the system stops at step 765. When more than one local vendor has the items on the list, an optimization engine similar to that described in connection with FIG. 13 may be employed to identify a preferred vendor location.

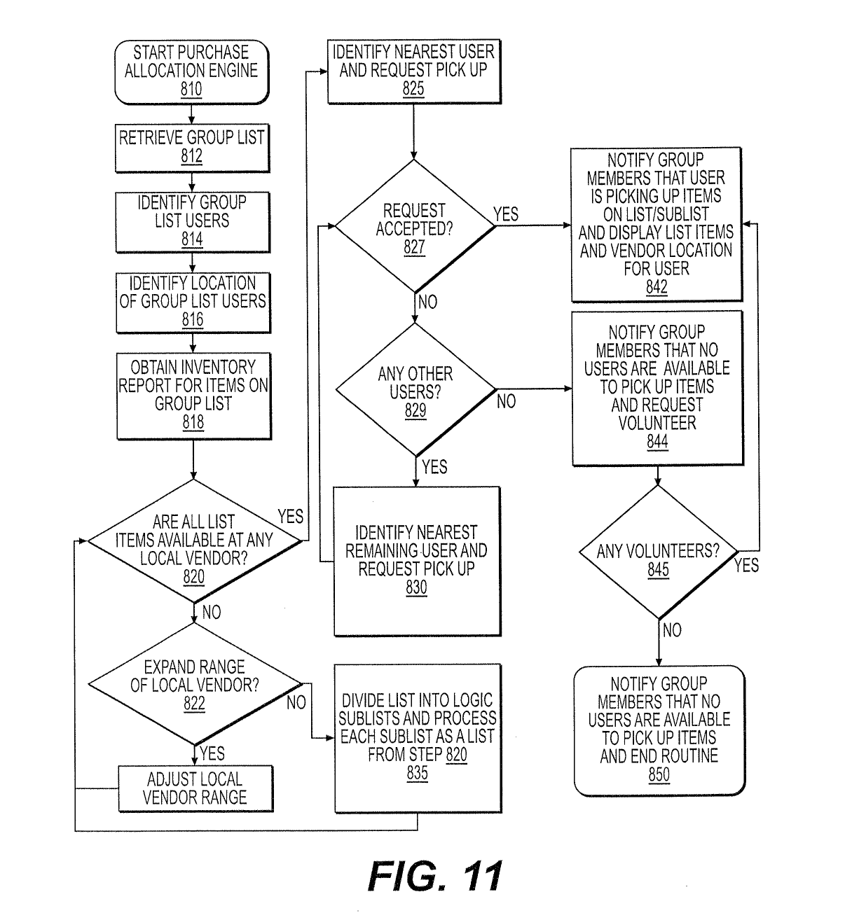

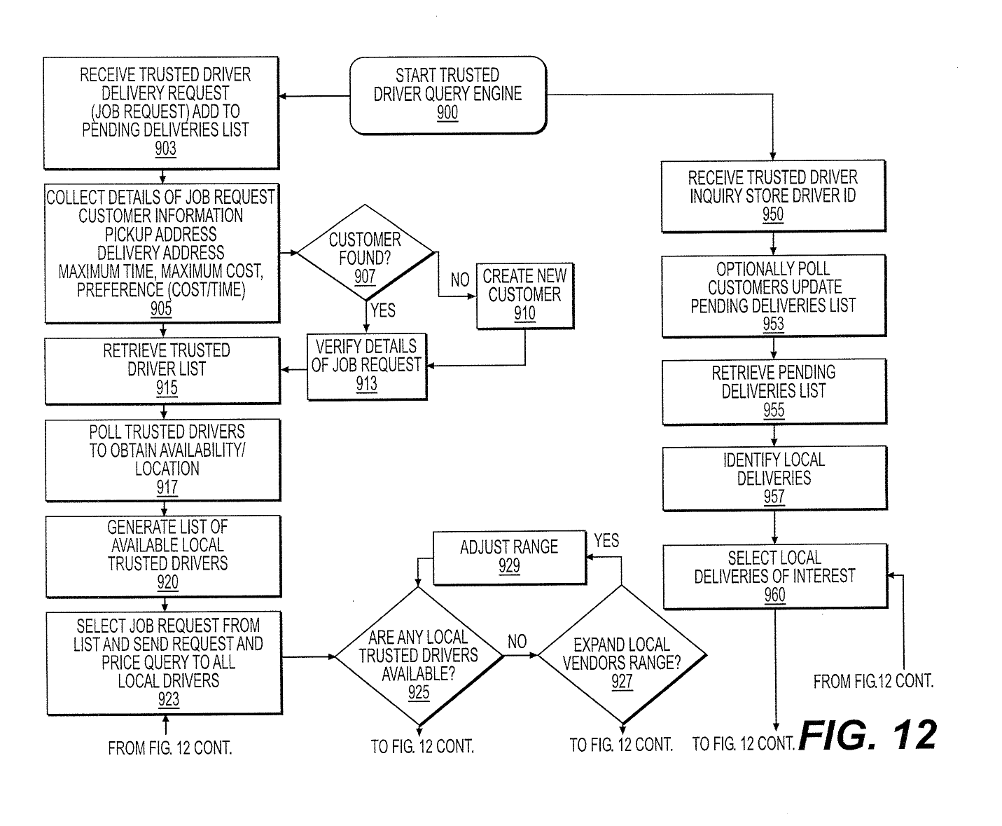

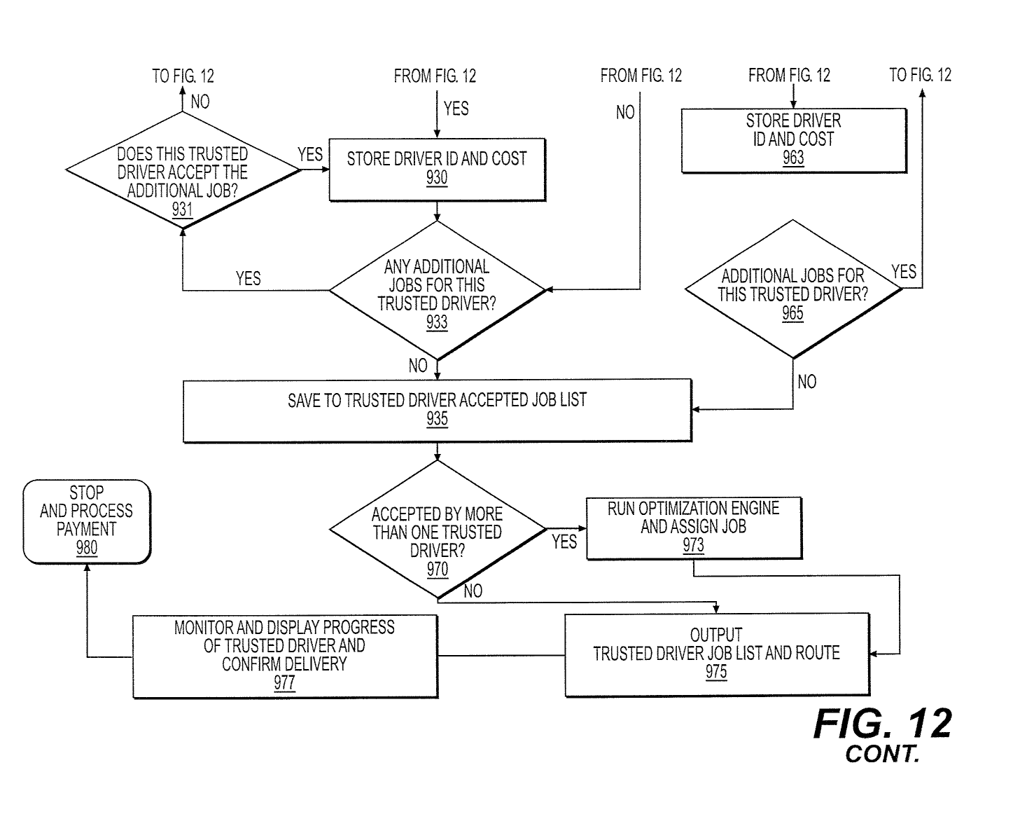

FIG. 11 is a flow diagram detailing an exemplary purchase allocation engine process. The purchase allocation engine is used to allocate purchasing responsibility among user group members. As shown, the process begins at step 810 with initiation of the purchase allocation engine. At step 812, the purchase allocation engine of the system retrieves the group list and, at step 814, the group list users are identified. Next, at step 816, the purchase allocation engine of the system identifies the location of all group list users. The identification of the location of group list users may be done by dynamically determining each user's location using a position location device of the type described herein or from reports from the users or information stored memory locations. Thus, for instance, if the relevant USER location is a residence, the location may be stored in a computer readable medium, but if the relevant user location is the present location of the user, the position should be determined dynamically. At step 818, the purchase allocation engine of the system obtains an inventory report for items on the group list. The inventory query engine may be used for this purpose or the information may be stored in memory. At step 820, the purchase allocation engine of the system determines whether all list items are available at any local vendor. If so, at step 825 the purchase allocation engine of the system determines the nearest user (based of distance or time) and requests that user to pick up the order. If all list items are not available at any local vendor, then the user is given the option of expanding the range of local vendors at step 822. Again, expanding the range of local vendors involves increasing the distance (or time) from the user that will be considered “local.” If the user chooses to expand the range of local vendors, the local vendor range is adjusted and the process repeats from step 820. Should the user decide not to expand the range of local vendors, the purchase allocation engine of the system divides the list to logical sub-lists and processes each sub-list as a list from step 820. Once the identification of the nearest user and request for pickup has been made at step 825, a determination is made, at step 827 as to whether the request has been accepted. If not, at step 829, the purchase allocation engine of the system determines whether there are any other users available who may be able to make the pickup. if not, then at step 844, the purchase allocation engine of the system notifies group members that no users are available pickup items and requests a volunteer. If there are other users as determined at step 829, then at step 830, the purchase allocation engine identifies the nearest remaining user and requests pickup and the purchase allocation engine of the system repeats from step 827. If the request is accepted at step 827, then, at step 842, the purchase allocation engine of the system notifies group members that the user is picking up items on the list or sub-list and displays list items and vendor locations for the user. If, at step 844, the purchase allocation engine of the system has requested volunteers, a determination is made at step 845 as to whether any users have volunteered if not the purchase allocation engine of the system notifies group members at no users are available to pick up items and either ends the routine step 850 or, optionally, invokes a trusted driver engine (distributed distribution system) of the type shown in FIG. 12 to obtain a quote for having the order delivered by a trusted driver. In this way, the purchase allocation engine of the system can provide an option for self-pick-up if convenient with use of trusted driver delivery as a back-up. If there are volunteers at step 845, then the purchase allocation engine of the system progresses to step 842 and members are notified that a user is picking up items.

FIG. 12 is a flow diagram detailing an exemplary trusted driver query engine. The trusted driver query engine is preferably designed such that users (for example, vendors or customers) can request delivery of an order, package or parcel by a trusted driver from a list of TRUSTED DRIVERS stored by the system. Alternatively, the trusted driver query engine of the system can accommodate requests for jobs received from trusted drivers using the system. The trusted driver query engine, together with the network of TRUSTED DRIVERS, proved a distributed delivery system that can be used in addition to or in lieu of customer pick-ups or vendor deliveries. As shown, the trusted driver query engine initiates at step 900. At step 903, the trusted driver query engine of the system receives a trusted driver delivery request (job request) and adds the request to the pending deliveries list. At step 905, the trusted driver query engine of the system collects details of the job request including customer information, pickup address, delivery address, maximum time, maximum cost and the user preference as to whether cost or time should take priority. All of this information is added to the newly created job request. At step 907, the trusted driver query engine of the system checks to see whether the customer making the request is a known customer. If not, at step 910 a new customer record is created. The trusted driver query engine of the system then proceeds to step 913 where the details of the job request are verified. For example, the trusted driver query engine of the system verifies that the pickup and delivery address are valid and that the maximum time and maximum costs are within reasonable limits and not erroneously entered (and ensures all required information has been entered). Next, at step 915, the trusted driver query engine of the system retrieves a trusted driver list from memory. The trusted driver query engine of the system then, at step 917 polls the trusted drivers to obtain availability and location of TRUSTED DRIVERS. A polling engine may be used for this purpose or the trusted driver query engine of the system may simply send messages to the trusted drivers in the system using contact information in the trusted driver profile. At step 920, the trusted driver query engine of the system generates a list of available local trusted drivers. In this context, local means within a specified distance (or time) from the pickup location. At step 923, the trusted driver query engine of the system selects one of the pending jobs (deliveries) from the list and sends a request and price query to all local drivers. At step 925, the trusted driver query engine of the system determines whether any local trusted drivers are available. If not, at step 927, the user is given the option of extending the local vendors range. If the user selects to expand the “local” vendor range (distance or time), then at step 929, the range is adjusted and the process repeats from step 925. If the user elects not to expand the local vendor range, then the trusted driver query engine of the system determines whether, at step 933, there any additional jobs for this trusted vendor. If so, the trusted driver query engine of the system gives the trusted driver the option to accept the additional job at step 931. At step 930, the trusted driver query engine of the system stores the driver ID and cost for accepted jobs. At step 935, the trusted driver query engine of the system saves the TRUSTED DRIVER accepted job to the to the trusted driver accepted job list.

Following the alternative path that begins at step 950 with receiving a TRUSTED DRIVER inquiry where the trusted driver query engine of the system stores the driver ID. At step 953, the trusted driver query engine of the system may optionally poll customers to update their pending orders/deliveries list. At step 955, the trusted driver query engine of the system retrieves a pending deliveries list which is a group list of all customers of the vendor. At step 957, the trusted driver query engine of the system identifies local deliveries. Again, local deliveries are those deliveries within a certain specified distance (or time) of the pickup point. At step 960, the trusted driver query engine of the system obtains a selection from the trusted driver of local deliveries of interest. At step 963, the trusted driver query engine of the system stores the driver ID and cost for the selected local deliveries of interest. At step 965, the trusted driver query engine of the system determines whether there are any additional jobs for this trusted driver. If yes, then the trusted driver query engine of the system reverts to step 960 and the driver is allowed to select additional local deliveries of interest. If there are no additional jobs for this trusted driver, then the trusted driver query engine of the system proceeds to step 935 and the jobs selected are saved in a computer readable medium to the trusted driver accepted job list. At step 970, for each job a determination is made as to whether job has been accepted by more than one trusted driver. In each such instance, the trusted driver query engine of the system at step 973 runs an optimization engine and assigns the job one of the trusted drivers based upon user preferences. At step 975, the trusted driver query engine of the system outputs a trusted driver job list. At step 977, the trusted driver query engine of the system monitors and displays progress of the trusted driver and confirms delivery. At step 980, the trusted driver query engine of the system stops the routine and processes payment for the respective parties. It will be appreciated that certain routines are repeated for each item on a list.

FIG. 13 is a flow diagram detailing an exemplary optimization engine process. As shown, the optimization engine begins at step 1000. At initiation, the optimization engine of the system inputs a maximum delivery time (step 1003), a maximum cost (step 1005) and a preference as to cost or time (at step 1007). With regard to the user preference that is input at step 1007, it should be noted that user has already input a maximum acceptable cost and a maximum acceptable delivery time. The preference input step 1007 indicates which factor, cost or delivery time, is most important for the user. In some instances, a user may prefer the lowest cost that satisfies the requirement of maximum delivery time. Conversely, a user may prefer the quickest delivery provided the cost does not exceed the maximum cost already specified. At step 1010, the optimization engine of the system stores the designated maximum time and maximum cost as the initial values for SELECTED delivery time and cost. At step 1013, the optimization engine of the system loads a driver ID and cost value. At step 1015, the system determines whether the cost associated with that driver ID is greater than the maximum cost. If YES, then at step 1017, the optimization engine of the system notifies the trusted driver that their estimated cost is greater than the maximum cost and provides the trusted driver with an opportunity to rebid (i.e., submit a new cost). At the same time, the optimization engine of the system starts a rebid clock and determines whether the revised bid was received within the time permitted. At step 1020, if no revised bid is received within the specified time, the optimization engine of the system proceeds to step 1025 to determine whether additional drivers are available. If yes, the optimization engine of the system repeats beginning at step 1013. If there are no additional drivers, the optimization engine of the system proceeds to step 1070 described below. If, at step 1015, is it is determined that the cost is not greater than the maximum cost, then the optimization engine of the system proceeds to step 1027 and retrieves the trusted driver location and determines estimated delivery time for each of the trusted drivers. The optimization engine of the system could use self-reported driver locations and or estimated arrival times, but such a system is not as reliable as an objective position location system that reports the trusted driver location and independently estimates the arrival time. For this reason, use of an independent location determination system is preferred. At step 1030, the optimization engine of the system determines whether the estimated delivery time is greater than the maximum time. If YES, the optimization engine of the system reverts to step 1025 and determines whether additional drivers are available. If the estimated delivery time is not greater than the maximum delivery time, then, at step 1033, the optimization engine temporarily stores the driver ID, cost and estimated delivery time. Next, at step 1035, the optimization engine of the system determines whether the user's preselected preference is for cost or time. In other words, whether the user would prefer the lowest possible cost of delivery provided the maximum time is not exceeded or, alternatively, the user would prefer to the quickest possible delivery time provided the cost does not exceed the maximum cost. If, the user selects the quickest possible delivery time, then, at step 1037, a determination is made as to whether the estimated delivery time is less than stored estimated delivery time. If so, the optimization engine of the system stores the temporary driver ID cost and estimated delivery time as the new values for the SELECTED driver ID cost and estimated delivery time at step 1050. If the estimated delivery time is determined, at step 1037, to not be less than the stored estimated delivery time, the optimization engine of the system determines whether the estimated delivery time is equal to the stored estimated delivery time at step 1039. If YES, then, at step 1040, the optimization engine of the system determines whether the cost is less than the stored selected cost (in which case the bid being evaluated would be a better value than the currently stored bid). If yes, then the optimization engine of the system stores the currently evaluated bid information, driver ID, cost and estimated delivery time as the new SELECTED driver ID cost an estimated delivery time, i.e. this bid is the new leading bid. In the event that, at step 1035, the user indicates a preference for the lowest possible cost, then, at step 1053, a determination is made as to whether the cost is less than the stored SELECTED value. If so, then the information temporarily stored is stored as the new selected driver ID, cost and estimated delivery time at step 1050. If, at step 1053, the cost is determined to not be less than the stored selected cost, then a secondary determination is made at step 1054 as to whether the cost is equal to the stored selected cost. If so, then a further determination is made, at step 1057, as to whether the estimated delivery time is less than the stored estimated delivery time frame in which case the newly evaluated bid would be preferable to the previously stored bid. If yes, then the information temporarily stored is then stored as the SELECTED driver ID cost an estimated delivery time. If the cost is not equal to the stored selected cost, then the optimization engine of the system proceeds to step 1025 and determines whether there are additional drivers to be evaluated using the process beginning at step 1013. If not, then the optimization engine of the system proceeds to step 1070, the system determines whether any drivers have been found for the job. If yes, the optimization engine of the system ends at step 1075 and returns the stored currently stored SELECTED driver ID, cost and estimated delivery time as the optimized selection. If no drivers have been found, then at step 1080, the optimization engine of the system notifies the user that no drivers have been found and prompts the user to select whether they want to restart the optimization engine. Should the user choose to restart the optimization engine, the optimization engine of the system proceeds to step 1000 above. Otherwise, the optimization engine of the system ends at step 1085.

As described above, the system of the present invention provides list based infrastructure that supports a distributed delivery system in which independent TRUSTED DRIVERS act as couriers to deliver orders, packages and parcels from vendors to customers. Naturally, a list based logistics engine supported TRUSTED DRIVER courier system may be used for other purposes as well. Depending on the geographic location and traffic conditions, the term “trusted driver” could encompass couriers using self-powered cycles, motorized cycles, automobiles and trucks, aircraft, watercraft and even walking couriers. In most instances, however, the TRUSTED DRIVERS will be operating motorized vehicles equipped with a smart device capable of digital communication and including position locating and reporting equipment. In contrast to a taxi type pick up system, the trusted drivers using the present invention may be able to pick up multiple loads for simultaneous transport to different but nearby locations when doing so makes logistical sense. A logistics engine may be used to support various adaptations of the trusted driver system. In this description of a distributed distribution system using trusted drivers, the currently preferred trusted driver is a human driver that is registered with the system and has been vetted to ensure reliability and safety. Currently, however, there are efforts to develop driverless car systems that operate on designated routes. To the extent such a system for driverless vehicles is implemented, the “trusted driver” would also encompass the controller of a driverless vehicle controlled by the system. The trusted driver distributed distribution system described herein preferably includes a logistics module or engine that allows a driver to be assigned multiple deliveries that make logical sense. For example, if a trusted driver is picking up a package for delivery from a grocery store and the grocery store has another pending delivery in the same neighborhood, the logistics engine of the system will identify the two deliveries as related by location and develop a preference for assigning both deliveries to the same trusted driver. Combining deliveries would ordinarily entail an adjustment to the fee paid by the vendor to the trusted driver. Thus, instead of paying full fees to the trusted driver, the pricing or logistics engine of the system could allocate a reduced fee for each of the deliveries or a reduced fee for the second (and subsequent) delivery. By determining the additional time entailed in the additional delivery, the pricing or logistics engine of the system preferably makes a fee calculation that preserves the incentive for the trusted driver to make the second (and subsequent) delivery while at the same time reducing the total cost to the vendor and/or customer. The logistic system compares the cost to all users, vendors and customers and the return to the drivers to ensure that by combining deliveries no one is disadvantaged. Thus, as the system identifies and arranges for multiple order/parcel deliveries, the logistics engine of the system continuously monitors whether the estimated delivery time for each package will still be under the maximum delivery time available for the delivery. For lower priority deliveries, the logistics engine of the system provides the customer an opportunity to specify a longer maximum delivery time, which increases the possibility of combining delivery job assignments and therefore offering reduced cost. In connection with the delivery of perishable other time sensitive deliveries, the logistics engine of the system may also assign a “maximum time in transit” value to the package. Thus, for example where a customer Grocery list includes milk, they may not care whether the package is delivered in the morning or the afternoon, but it is important that the package not be in transit for several hours in a non-refrigerated vehicle during the course of a hot day. To facilitate this feature, the vendor information IT system may include inventory information associated with each product that identifies the maximum time in transit for each product. Thus, as the customer develops a list of items to buy, the logistics engine of the system is storing the maximum time in transit for each product so that the information can be used by the logistic system later. The maximum time in transit for any order is determined by identifying the shortest possible time in transit for any item in the order. By configuring deliveries into sub-deliveries, the logistics engine can coordinate making priority deliveries first and lower priority orders can be deferred to seek a lower delivery cost.

As described, the present invention supports a distributed distribution system in which the delivery of orders/parcels/messages/packages of goods from one location to another is supported. The system includes a logistics module for combining package deliveries in an efficient manner and a storage means for storing information as to the maximum time in transit. The logistics engine of the system preferably provides a “safety factor” that ensures that the maximum time in transit is not exceeded. For example, if a delivery contains perishable products such as milk that is determined to have a maximum time in transit of two hours the system allows the user to set a factor of safety of 0.5 so that the package containing the perishable milk will not be included in any delivery that takes more than 2.0×0.5 hours or one hour. From the foregoing, it is clear that, in a large order, a single perishable item or other time sensitive delivery item could impact the priority of entire package delivery. In such instances, it is possible that the overall delivery cost could be reduced by breaking the order into multiple deliveries with the high priority time sensitive deliveries being placed in a different delivery package than other lower priority delivery packages. However, depending on the capacity of the particular trusted driver (courier), it may be efficient to combine nearby lower priority deliveries with time sensitive deliveries to avoid the need for a second delivery. Thus, the logistics engine of the system gives the user and customer the option of dividing deliveries into different shipping packages to reduce shipping cost. It should be understood that in some instances, the customer may not want to have packages delivered it multiple times. For example, if the customer is not always at the delivery location (e.g., their home) it may not be convenient to have deliveries coming at different times. Thus, in this example, the customer would opt out of the multiple delivery option and may therefore incur additional cost. Another way to address the issue of perishable items is the enlist one or more trusted drivers that have vehicles equipped with refrigeration or warming devices to keep the products at or near the intended temperature thus extending maximum delivery times. In such instances, the availability of such equipment will be stored in the TRUSTED DRIVER profile and used by the logistics system as a factor in allocating deliveries.

As noted, the system includes a pending deliveries list. Using information on this list, the trusted drive or logistics engine of the system may alert drivers to the impending unfilled delivery orders. The TRUSTED DRIVER could respond with a message indicating the driver's delivery capacity and any special equipment such as refrigeration equipment or warming equipment to keep food or other items cool or warm. Using the polling engine of the invention, the logistics engine of the system may send an alert that a package (which may contain multiple deliveries) will be available within a specified period of time. In this way, if a trusted driver is in the vicinity they may opt to stay in the vicinity to wait for the pending delivery order. An advantage of the distributed distribution system of the invention is that the users of the distributed distribution system, which may include stores, households, service providers that need document deliveries (e.g., law firms) need not invest in the infrastructure of maintaining and supporting a permanent delivery capacity. Restaurants such as pizza delivery restaurants and takeout food restaurants may also take advantage of this system to supplement or replace an existing delivery team by utilizing trusted drivers on a demand basis as opposed to a full-time basis. While the system supports a completely independent driver system, the system can also support subsidized drivers or driver infrastructure that is supported entirely by a particular “customer.” Thus, for example a grocery store, retailer or restaurant that has extensive delivery needs may subsidize drivers by providing the vehicles or supporting the purchase of vehicles to encourage the drivers to affiliate with that particular system operator. Likewise, to the extent that driverless vehicles are practical within a certain delivery range, the system operator or customer may invest in the driverless vehicles to be used as trusted drivers. From the perspective of vendors and customers, the system offers the benefit of providing the lowest possible cost to deliver goods. From the perspective of the vendor, the system is also beneficial because there is no need to invest in delivery infrastructure such as the purchase of delivery vehicles and the like. Instead, the vendor may use the system to access trusted drivers who have already negotiated terms with the system operator. The distributed order fulfillment and distribution systems described herein yield energy savings and greenhouse gas reduction by reducing greenhouse gas emission reduction associated with unnecessary trips and deliveries.

From the perspective of the trusted driver, the system provides an opportunity to take advantage of travel that has been planned and earn some income by delivering a package along the route or nearby the route. In addition, because trusted drivers may accept more than one job along the same path, there are opportunities to optimize logistics by having drivers carry multiple packages. From the perspective of the trusted drivers, the system is also beneficial because the system operator can handle all financial transactions associated with the job performance which simplifies the job of the Courier. In this way, the system provides a smart device enabled on demand delivery pickup and delivery service.

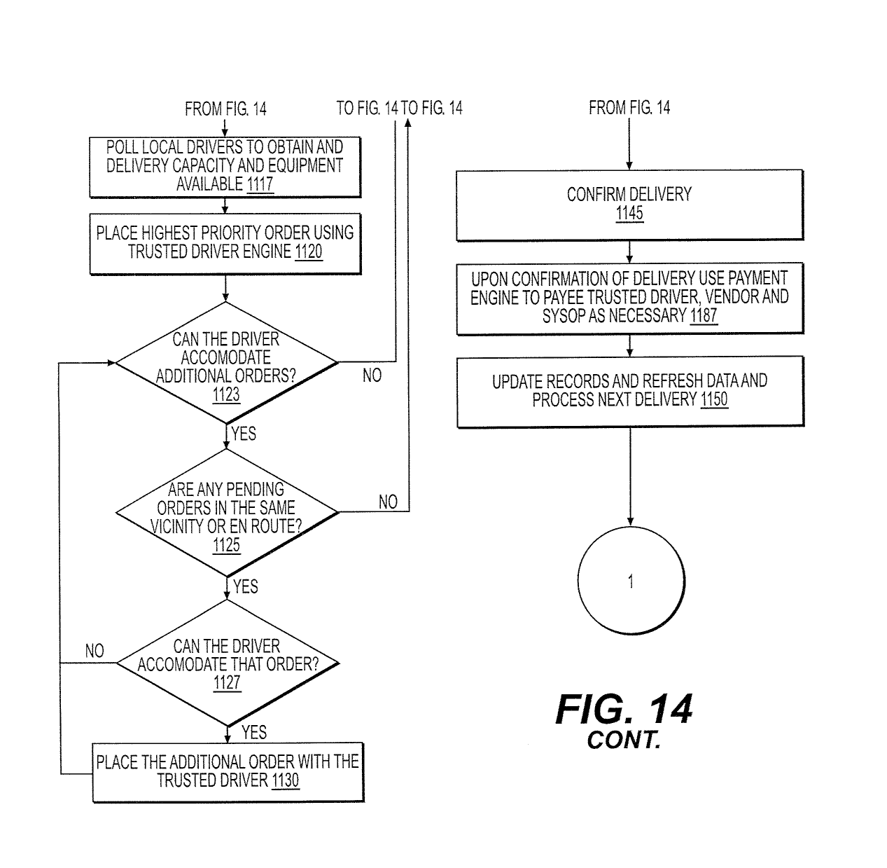

FIG. 14 is a flow diagram detailing an exemplary, somewhat simplified, logistics engine process. As shown, the process begins at step 1100 with the initiation of the logistics engine. Next, at step 1103, the logistics engine of the system retrieves a list of pending deliveries to be processed. At step 1105, the logistics engine of the system obtains and stores maximum time in transit for each order item. At step 1107, the logistics engine of the system obtains and stores user preferences as to whether deliveries may be divided into sub-orders. At step 1110, the logistics engine of the system obtains and stores user preferences as to the delivery time preferred. For example, if a person is not home during the day, they may specify a preference for delivery in evening hours. As discussed above, other factors can be taken into account in operating the logistics engine. At step 1113, the logistics engine of the system determines order priority based on maximum time in transit and user preferences, for example. Other factors could be used to determine delivery priority, if desired. At step 1115, the logistics engine of the system uses identifies possible local drivers using stored or dynamically generated location position information. At step 1117, the logistics engine of the system uses a polling engine to poll the local drivers to obtain availability and delivery capacity and equipment available information. At step 1120, the logistics engine of the system places the highest priority order using the trusted driver engine. At step 1123, the logistics engine of the system determines whether the driver can accommodate additional orders. If yes, the logistics engine of the system proceeds to step 1125 and determines whether there are any pending orders in the same vicinity en route for the driver's upcoming delivery order. If yes, the logistics engine of the system determines whether the driver can accommodate that specific order. If yes, the logistics engine of the system places the additional order with the trusted driver at step 1130. The logistics engine of the system then proceeds back to step 1123 and repeats the process until a determination is made that either the driver cannot accommodate any additional orders or that there are no pending orders in the same vicinity or en route. In these instances, the logistics engine of the system proceeds to step 1133 and proceeds to finalize job pickup and delivery instructions and transmit the same to the trusted driver. Next, at step 1135, the logistics engine of the system confirms that the order for delivery has been picked up by the trusted driver. Then at step 1137, the system tracks the trusted driver en route and displays the trusted driver en route location and updates delivery time in real time at step 1140. As the driver approaches the delivery location, the logistics engine of the system may optionally, at step 1143, notify the customer of the trusted driver's impending arrival at location. At step 1145, the logistics engine of the system confirms delivery. At step 1147, upon confirmation of delivery, using a payment engine, the logistics engine of the system pays the trusted driver, vendor and SYSOP to the extent necessary. At step 1150, the logistics engine of the system updates records and refreshes data preparation processing the next delivery as the system returns to step 1103. The logistics engine described in FIG. 14 may be continuously run to process orders as they are received. It should be noted that the entire process could be run without compromising the identity of the customer (though a delivery to a home could reveal some personal information.

The technology used to implement an exemplary trusted driver distributed distribution system is divided into two components, the smart device APP technology for vendors and consumers and the demand calculation technology at the system operator. The app technology is available for smart devices and uses position location determining hardware and software of the type described herein to display (e.g., on a map) local (from the requested pickup destination) of available trusted driver vehicles in the area. The system operator calculates the nearest driver and plots the pickup time. Each driver is also given a smart device with an app to manage incoming customer requests. The system operator may employ prediction algorithms and historical records to predict expected demand at different times of day. The system analyzes how many times the app is open and where clusters are located to help manage the supply of trusted drivers.

The system stores financial information sufficient to ensure that all payments and service fees can be paid as soon as delivery is confirmed.

As used herein, a location positioning system is a mechanism for determining the location of an object in space. Well known technologies for this task exist ranging from worldwide coverage with meter accuracy to workspace coverage with sub-millimeter accuracy. The Global Positioning System (GPS) is a space-based satellite navigation system that provides location and time information in all weather conditions, anywhere on or near the Earth where there is an unobstructed line of sight to four or more GPS satellites. The system provides critical capabilities to military, civil and commercial users around the world. It is maintained by the United States government and is freely accessible to anyone with a GPS receiver.

Wi-Fi-based positioning systems may be used where GPS is inadequate due to various causes including multipath and signal blockage indoors. Such systems include indoor positioning systems. Wi-Fi positioning takes advantage of the rapid growth in the early 21st century of wireless access points in urban areas. The localization technique used for positioning with wireless access points is based on measuring the intensity of the received signal and the method of “fingerprinting.” The accuracy depends on the number of positions that have been entered into the database. The possible signal fluctuations that may occur can increase errors and inaccuracies in the path of the user. To minimize fluctuations in the received signal, there are known techniques that can be applied to filter the noise.

An indoor positioning system (IPS) is a network of devices used to wirelessly locate objects or people inside a building. Instead of using satellites, an IPS relies on nearby anchors (nodes with a known position), which either actively locate tags or provide environmental context for devices to sense. Unambiguous locating service requires at least three independent measures per target. For smoothing to compensate for stochastic errors there must be a mathematical over-determination that allows for reducing the error budget. Otherwise the system must include information from other systems to cope for physical ambiguity and to enable error compensation.

Hybrid positioning systems are systems for finding the location of a mobile device using several different positioning technologies. Usually GPS (Global Positioning System) is one major component of such systems, combined with cell tower signals, wireless internet signals, Bluetooth sensors, IP addresses and network environment data, or other local Positioning Systems.

Hybrid location positioning systems are specifically designed to overcome the limitations of GPS, which is very exact in open areas, but works poorly indoors or between tall buildings (the urban canyon effect). By comparison, cell tower signals are not hindered by buildings or bad weather, but usually provide less precise positioning. Wi-Fi positioning systems may give very exact positioning, in urban areas with high Wi-Fi density—and depend on a comprehensive database of Wi-Fi access points.

According to another aspect of the invention, hardware and software enable various system users to exchange lists easily. As noted, copies of lists are stored in cloud based storage that is accessible by system users. A synchronization engine in the electronic list APP ensures that affiliate (group) lists are automatically shared among members of an affiliate group. In addition, there are instances where it is desirable to share list in an ad hoc manner. For example, an advertisement for a recipe requiring certain ingredients may include a printed list of ingredients, but it would be beneficial to be able to readily upload the list into the electronic list app. In addition, there may be instances where two independent users of the system would like to exchange lists with one another. Naturally, documents or emails of list items may be exchanged, but a more expeditious way to exchange lists in the electronic list app would be beneficial. To address these needs, the system includes a LIST EXCHANGE ENGINE to facilitate ad hoc exchange of lists stored in the system.

The LIST EXCHANGE ENGINE includes hardware and software for creating optically readable matrix barcodes (i.e., two-dimensional barcode) that direct a user to a downloadable list stored in cloud storage. In this context, a “barcode” is a machine-readable optical label that contains information about the item to which it is attached. Among barcodes, two-dimensional codes (e.g., QR codes) are preferred due to fast readability and greater storage capacity compared to standard UPC barcodes. As an example of the list exchange engine, a user selects a list for exchange and selects an option to “convert to QR code” to initiate a QR CODE GENERATING ENGINE that creates a QR code that encodes (optionally) either the list itself (for direct transfer) or a link to a cloud based site for downloading the list per se. A second user scans the QR code using a QR code reader and the list is uploaded into their smart device and stored and/or displayed.

In another example of the list exchange engine in use, the engine is used to generate a QR code to be printed or otherwise used in an advertisement for a recipe. The QR code is generated to encode either the list of ingredients itself (for direct transfer) or a link to a cloud based site for downloading the list per se. A second user scans the QR code using a QR code reader and the list is uploaded into their smart device and stored and/or displayed. The linked site, may optionally include an interface that receives user input as to quantity (for example number of servings) so the ingredient list could be scaled to the quantity desired.

The list exchange engine may also be used to encode lists that will be used in conjunction with a promotion contained on packaging. The lists encoded may include a list of related items to the item in the package.

Known matrix bar codes consists of black modules (square dots) arranged in a square grid on a white background, which can be read by an imaging device (such as a camera) and processed using Reed-Solomon error correction until the image can be appropriately interpreted; data is then extracted from patterns present in both horizontal and vertical components of the image. In use, a smart device (or dedicated scanner) is used as a QR-code scanner, displaying the code and converting it to some useful form (such as a standard URL for a website, thereby obviating the need for a user to type it into a web browser).

As described, the QR code provides quick and effortless access to a list stored in the system by another user, an advertiser or anyone else. The list exchange engine thus facilitates the exchange of lists by identifying a list to be exchanged based on user input; encoding the list contents (list items) and/or a link to web site containing the list contents (list items) as a matrix bar code and publishing (sending) or displaying and the matrix bar code. QR codes storing addresses and Uniform Resource Locators (URLs) may appear in magazines, on signs, on buses, on business cards, or on almost any object about which users might want information. Users with a camera phone equipped with the correct reader application can scan the image of the QR code to display text, contact information, connect to a wireless network, or open a web page in the telephone's browser. The act of linking from physical world objects is termed hardlinking or object hyperlinking. QR codes also may be linked to a location to track where a code has been scanned. Either the application that scans the QR code retrieves the geo information by using GPS and cell tower triangulation (aGPS) or the URL encoded in the QR code itself is associated with a location.

QR codes can be used in Google's Android, BlackBerry OS, Nokia Symbian Belle and Apple iOS devices (iPhone/iPod/iPad), as well as Microsoft's Windows Phone operating system, Google Goggles, 3rd party barcode scanners, and the Nintendo 3DS. The browser supports URL redirection, which allows QR codes to send metadata to existing applications on the device. Mbarcode is a QR code reader for the Maemo operating system. Google Goggles is an example of one of many applications that can scan and hard-link URLs for iOS and Android. BlackBerry 10 devices have a native QR reader as well as several third party readers. QR codes can be used to store bank account information or credit card information, or they can be specifically designed to work with particular payment provider applications. QR codes are commonly used in the field of cryptographic currencies, particularly those based off and including bitcoin as described herein. Payment addresses, cryptographic keys and transaction information are often shared between digital wallets in this way.

To facilitate the use, maintenance and management of lists stored in the system, the system further included scanners (either dedicated scanners or smart devices running scanner apps) and a SCANNING ENGINE that associate physical items with list items stored in a user list. The scanners receive an image of a physical item, which can range from a photo of a building, landmark, person or product (processed by the image recognition engine), to a bar code identifying a particular product. The image is processed (by the IMAGE RECOGNITION ENGINE, QR code reader, bar code reader etc.) as appropriate to identify a unique item. The item identified is then compared to stored list items by the scanning engine to see if a match can be found. When a match is found, the list may be modified according to stored instructions or user instructions. For example, if the list item is from a list of “places I've always wanted to see,” the user may select “done” to indicate that they have now seen that landmark. In the context of shopping, the list item matched may be an item from a shopping list that is flagged as “in the cart” once scanned and added to a list of items to be purchased with the cost automatically added to the total cost of items in the cart, all according to a stored instructions.

In addition to facilitating use, maintenance and management of lists stored in the system, scanning devices according to the present invention may be used to help users locate list items. In particular, the electronic list application and scanning engine may be used in combination with location guidance hardware and software to guide users to the location of a list item. For example, a STORE GUIDANCE ENGINE may be used to receive location signals from a user device (e.g., a smart device running a scanning app or a dedicated store scanner) and process the location signals together with stored inventory data to generate signals displayed on the user device and/or hardware in the store (e.g., video display panels, LED indicators built into shelves). Thus, a user looking for a particular list item approaches a video display panel, initiates the store guidance engine, selects a list item on their handheld device to send a signal received by the store guidance engine, the store guidance engine queries the inventory engine to ascertain the location of the selected item and generate a display providing directions within the store. The use of a separate video display panel is optional since directions to the selected items could be provided on the hand held device itself, but the video display panel may allow a more interactive experience such as a virtual customer service agent.

An example of a known scanner is the “Scan It” hand held RFID device that allows customers to scan the bar code of each item they put in the shopping cart. As the customer navigates the store, personalized relevant messages are delivered based on location in store as well as purchase history. With these scanners, shoppers scan and bag their own groceries as they navigate the aisles, while a screen keeps a running total of their purchases. A Scan-It app allows people to scan items with a barcode reader on their phones, keeping a tally of what they've put in their carts and displaying the amount of money they've saved through personalized discounts along the way. Opt-in self-scanning mobile apps can trace purchase pathways in a less invasive way than by, which some retailers do today without notifying consumers.

There are known technologies for in store location detection, including, for example, tracking phones (or scanners) via Wi-Fi signals or determining where someone is by virtue of the product just scanned or through the use of an Indoor Positioning System (IPS). Thus, a user can report their location by scanning any item in the store to allow the location detection engine to match the user to the location of the time in the store. Real-time location data can be combined with purchase history and cart contents to generate offers that are more customized than if they were solely based on proximity to other products. For instance, if a shopper who typically buys almond milk scans a box of cereal, the user might be targeted with a discount on almond milk, rather than dairy milk, when the user reaches the refrigerated section. Either actual location detection (e.g., by RFID tag, IPS or WiFi tracking) or inferential location detection (e.g., by last item scanned) may be used by the store guidance engine.

An exemplary use of in-store scanners is a grocery store that provides dedicated scanning devices and/or a smart device scanning APP to facilitate a shopper's self-checkout. In either instance, when a user buys an item they can pick the item off-the-shelf, scan it by scanning the bar code and the scanning app generates data to maintain an ongoing list record of purchases. The scanning device is picked up or the scanning app enabled when the user checks in at the check-in station located at the store.

As used here, the check-in station is a station located at a remote location (namely the store) that is in communication with the system of the invention. The user check-in station may be a biometric reader, a card swipe, a user interface for text or voice input or a wireless check-in station that receives communication from a smart device either through user input, near field communication or an RFID tag. In any instance, the check-in station sends a signal to the system indicating that the user associated with a particular user ID is physically at the remote location.

In addition, the user equipped smart device or scanner may include an interface with a SHOPPING GUIDE ENGINE. The shopping guide engine receives signals (e.g., from the location detection engine) that indicate where the user (or more accurately the scanning device held by the user) is located within the store. The shopping guide engine further receives a list item selection from the user, either by user selection or according to a route plan generated to guide the user to all items on a list. The shopping guide engine initiates the inventory query engine to ascertain the location of the selected item in the store. The shopping guide engine compares the user's current location to the item location and generates a preferred route. The shopping guide engine generates a list or sequence of directions to guide the user from the present location to the item location according to stored preferences. The directions may be displayed on the USER's handheld device and/or displayed on a separate display panel. The progress of the USER through the store is monitored and stored using location tracking equipment (e.g., WiFi, RFID or NFC). As the USER nears the selected item, the shopping guide engine generates a beacon signal. The beacon signal preferably triggers a visual beacon indicator, such as a LED light on the shelf turning on in a particular color to indicate that the item selected by that user is on that shelf. Alternatively, or in addition, the signal could generate a notification on the handheld device display.

A ROUTE PLANNING ENGINE is provided in accordance with another aspect of the invention. The route planning engine may be used in conjunction with the shopping guide engine to generate a path for a user according to predetermined preferences. In the example of a retail store described above, the preferences could be as simple as “most efficient route possible.” However, the USER profile could generate routes other than the most efficient route to satisfy a user or vendor preference such as “avoid sugared cereal displays” or “avoid candy displays.” In addition, the VENDOR may make arrangements with suppliers to route shoppers past certain displays when the USER list contains certain items. Thus, the ROUTE PLANNING ENGINE can generate routes and provide direction for paths that different from the most time/travel efficient paths but which satisfy stored user preferences. Naturally, this feature of the ROUTE PLANNING ENGINE is useful in other contexts and is not limited to planning routes through retail stores. Such preferences are entered into the system using a user interface and stored in association with the USER profile and/or VENDOR system. The route planning engine may be used to locate a specific list item or to plan a path that encompasses the location of all items on the list. In either example, the route planning engine retrieves the USER preferences (if any) and checks the vendor system records to see if there are any route planning engine instructions associated with the list items. Based on these inputs the route planning engine generates an optimized path for the user (based on stored preferences) and generates signals sufficient to allow the guidance engine to display or otherwise provide directions to the user.

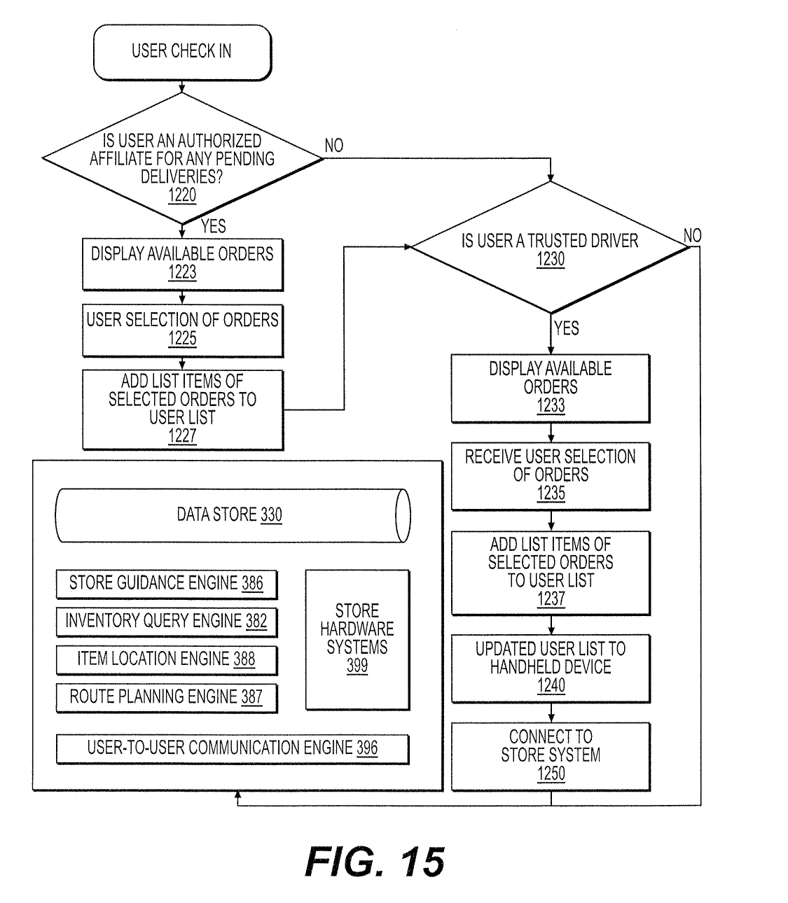

As described above, the system includes infrastructure supporting a distributed distribution system in which independent drivers (couriers) are enlisted in real time to act as couriers to deliver orders, packages and parcels from vendors to customers. While the system described can be used to “call” drivers to a job, the distributed distribution system is even more efficient when drivers are already on site. To that end, the invention further provides a DRIVER ORDER and DELIVERY ENGINE [DODE] for facilitating pick-up and delivery of list items of other users. As shown in FIG. 15, in an embodiment, upon check-in (step 1210), the system determines whether the user is eligible to pick up orders on behalf of others. There are two general examples where a user may be qualified pickup orders on behalf of others. First, the user may be an AUTHORIZED AFFILIATE, authorized to pick up orders placed by certain affiliates of the user. In each case, the affiliate has authorized (either by a stored preference or by an order specific authorization) the specific user to make a pickup on its behalf. The orders picked up by the user could be prepackaged orders already assembled by the vendor and ready for delivery or a list of items that the user is authorized to pick up on behalf of the affiliate. The second general example where an authorized user may be authorized to pick up items or prepackaged orders on behalf of another is in the case of a TRUSTED DRIVER that has previously been verified by the system operator or vendor for delivery of items of others.

In either the case of the AUTHORIZED AFFILIATE user or the TRUSTED DRIVER, upon check-in at the store location 1210, the system identifies the user and determines whether the user is an AUTHORIZED AFFILIATE (step 1220) and/or a TRUSTED DRIVER (step 1230). If the user is an AUTHORIZED AFFILIATE the system checks pending orders to see whether the user is authorized to pick up any pending orders either as an authorized affiliate or as a trusted driver. The system identifies and displays all possible orders that are available for pickup by the user at step 1223. Thus, for example, the system may identify four pending orders and display summaries for an AUTHORIZED AFFILIATE as follows:
Bob and Carol; three items; 0.5 miles away from home YES? NO?
Ted and Alice; 17 items; 0.2 miles from home YES? NO?
John; one item; 0.5 miles from home YES? NO?
Susan; three items; 0.0 miles from next destination YES? NO?

Note that the 0.0 distance for the items for “Susan” indicate that the items will be delivered to the AUTHORIZED AFFILIATE's next destination. The user may obtain details of the list items in an order by selecting the respective line summary. In every instance where possible pending order for delivery has been identified, the user is given a choice whether to accept the delivery or not [YES? NO?]. The engine receives the user's selection(s) at step 1225. When the user accepts the delivery, the list items included on the order/delivery are automatically added to the user shopping list (assuming that the order is not a prepackaged order) at step 1227. If the user opts to deliver one or more orders, they are given the option (generally after purchase) of initiating the route planning engine to generate a route for delivery of all selected orders according to stored or selected preferences. The route planning engine also preferably generates an estimated time for all deliveries and provides the USER the option of changing previous selections if the delivery time is unacceptable. The display preferably indicates either by color or icon that the user can see which list items are from the user's own list and which list items are for other users.

The engine next proceeds to step 1230 to determine whether the user is a trusted driver and a similar process is followed.

Having thus checked in and received a list of items to be purchased (the list representing the combination of the user's own list items and the list items that they agree to pick up), the updated list is downloaded to the handheld device at step 1240 and the user's smart device or in-store scanner displays a list of all items to be purchase. The user's handheld device then communicates with the store and/or could infrastructure to facilitate various engines described herein. For example, the USER may enable route planning (using the route planning engine 387) and/or shopping guidance (using the Store Guidance Engine 386) by virtue of selections stored in a computer readable medium or selections made at the time of check-in or during shopping. As described, the shopping guidance system includes hardware within the store working in conjunction with the user's smart device or store provided scanner and the shopping guidance (guide) engine. The shopping guidance engine 386 receives signals from hardware systems 399 within the store indicating the location of the user (or more accurately the user's smart device or scanner) within the store. The in-store position determination is accurate enough to identify not only what aisle the user is located in but also the user's location along the aisle. The inventory query engine 382 allows the user to query the store's inventory system in Data Store 330 to identify where list items are located within the store. Once the location of the list items has been determined, the system may initiate the route planning engine 387 to determine a preferred path for the user through the store. In many instances, an objective of the route planning system would be to determine the most efficient path of the user through the store. However, the invention is not so limited, in some instances the route planning system is used to direct the user along a path that is not the most efficient path (with regard to time/travel) past a featured item (or to avoid a display of specified items). The determination of which featured items to direct the user past depends both on sponsor incentives (for example, the supplier of a product provides an incentive to promote its product to users with certain list items or their respective lists) and an analysis of the user's past purchases and or list items using information obtainable through the system.

The ITEM LOCATION GUIDANCE ENGINE 388 works in conjunction with signals received from hardware 399 within the store and also includes software for generating signals to the store to activate and control item location guidance equipment. For example, the shelves in the store may include visual or audio beacon indicators to indicate a specific location within the store where a list item may be found. Thus for example, when the user selects a particular list item, a signal is sent from the user's scanner or smart device to the location guidance engine running on a processor and the location guidance engine determines the precise location within the aisle of the selected item and then sends a signal that causes a video or audio location signal (beacon). In one embodiment, the shelves in the store are equipped with LED lights and the light nearest the selected item can be illuminated as a “beacon” to guide the user to the location where the desired item can be found.

As noted, the driver order and delivery engine [DODE] is initiated in two types of circumstances that present an opportunity for the driver order and delivery engine to allocate pending orders to other users. First, there is the AUTHORIZED AFFILIATE who has been authorized by another user(s) to receive copies of the user's list and to pick up and deliver the items on that list.

In the second example, the user checks into the store and is identified as a TRUSTED DRIVER at step 1230. A TRUSTED DRIVER is a user that has previously been vetted by the system operator or store to ensure that the user is a reliable user. The TRUSTED DRIVER's performance is subject to continual monitoring and evaluation and if the user fails to perform to TRUSTED DRIVER standards, the TRUSTED DRIVER qualification may be revoked. When a TRUSTED DRIVER user checks in, the option to deliver today comes up automatically. The user's handheld device (or other display) displays pending orders (step 1233) based on the trusted driver's known home location, work location or next destination, for example. The trusted driver may input data such as how far they are willing to travel from their home or default information may be stored in the TRUSTED DRIVER profile. By way of example, upon check-in, the system identifies a user as a TRUSTED DRIVER and proceeds to issue a series of queries determine whether the user would like to make deliveries at that time. Based on input received from the trusted driver, the engine identifies pending orders, if any, that fall within the criteria set by the trusted driver (or default criteria stored in the TRUSTED DRIVER profile). The trusted driver typically would have a smart device app with a user interface or in-store scanner device. Whatever device the trusted driver is using, displays the possible orders available to that trusted driver. To preserve anonymity, the name of the users who placed the pending orders is not listed (unless authorized). If the recipient desires even more anonymity, the delivery can be made to a designated pick-up point. For example:
6001 Berkshire Dr., 7 items; 0.3 miles from home Yes? No?
Grosvenor Metro Park & Ride; 5 items; 1.8 miles from home Yes? No?
737 Cheshire Dr.; 3 items; 0.8 miles from home Yes? No?
850 Loan Oak Drive; 7 items; 1.2 miles from home Yes? No?

Here, the Grosvenor Metro Park & Ride is a designated pick-up point. The TRUSTED DRIVER selects one or more of the available pending orders at step 1235 and the list items associated with the pending orders are transferred to the trusted driver's device (e.g., by the SYNCHRONIZATION ENGINE) at step 1237 so that the trusted driver knows which items to buy. If the TRUSTED DRIVER is to deliver one or more orders, they are given the option (generally after purchase) of initiating the route planning engine 387 to generate a route for delivery of all selected orders according to stored or selected preferences. The route planning engine also preferably generates an estimated time for all deliveries and provides the TRUSTED DRIVER the option of changing previous selections if the delivery time is unacceptable. The DRIVER ORDER and DELIVERY ENGINE [DODE] can also be initiated to calculate the payment to be earned by making the deliveries as planned.

The invention further provides a PEER TO PEER COMMUNICATION ENGINE 396 to allow communication, including anonymous communication, between the TRUSTED DRIVER (shopper) or AUTHORIZED AFFILIATE (shopper) and the USER (customer) that made the order. Thus, for example if the trusted driver agrees to purchase milk on behalf of another user, the trusted driver accepts the order and proceeds to scan items associated with the item and eventually check out. When the TRUSTED DRIVER accepts the order, a notification is sent immediately to the USER who placed the order to avoid duplicate fulfillment. The notification message preferably includes a link to site that allows the USER who placed the order to monitor the order fulfillment in real-time. As items are scanned, the scanning engine can provide real time updates to the USER who placed the order (i.e., the person who wants the milk) so that USER can monitor the order fulfillment (i.e. see that their order is being filled and the specific items selected). The USER monitoring the purchases in real time or at checkout can initiate communication by menu selection, text or voice to veto or reject a selection. If communication is by voice or text, the customer has the option to connect to the shopper and give any specific or supplemental specifications (e.g., “2% not SKIM” or “COKE not PEPSI”). For example, the person placing the order may note that the TRUSTED DRIVER or AUTHORIZED AFFILIATE bought an item that is not exactly what the customer had in mind. As noted, the communication between the person who placed the order and the person fulfilling the order can be entirely anonymous, if desired. At checkout, the USER who placed the order has another opportunity to connect with the buyer and give any specifications, preferences or additional instructions. If not received already, at checkout the TRUSTED DRIVER receives the location of the drop off (whether it be an office or home or other meeting place) and proceeds to drop off the order (e.g., milk) at the specified location. The Buyer receives milk and money from her account is transferred to the SYSOP to pay the VENDOR or purchaser and the TRUSTED DRIVER delivery fee. The Payment engine may be used for this purpose. The Buyer then can rate the performance of Trusted Driver and leave a note about her experience. The ratings of buyers are used together with objective metrics such as timeliness and safety to monitor the performance of drivers continually.

When an AUTHORIZED AFFILIATE enters the store and checks in, she is not given the option to see public lists unless she also happens to be a Trusted Driver. Instead, the AUTHORIZED AFFILIATE is given the option to see the lists of people she is connected with who have designated her as an AUTHORIZED AFFILIATE. Users preferably all have payment accounts with the system so that the AUTHORIZED AFFILIATE need not advance funds to pay for purchases, but the system will permit users to places orders to be paid by the AUTHORIZED AFFILIATE. In this example, the AUTHORIZED AFFILIATE is notified that her neighbor Sandy (located just 0.1 miles from home) has a pending list with 3 items. The AUTHORIZED AFFILIATE agrees to pick up the order and Sandy is immediately notified and sent a link to monitor the order fulfillment. The immediate notification sent to the user who placed the order is important to avoid duplicate fulfillment of orders. Sandy may choose to monitor the fulfillment and communicate with the AUTHORIZED AFFILIATE, but such communication is not necessary. AUTHORIZED AFFILIATE proceeds to check out and is reminded of Sandy's address or notified of another specified location. AUTHORIZED AFFILIATE delivers the 3 items to Sandy and Sandy reimburses the AUTHORIZED AFFILIATE for any funds advanced, using the payment engine if desired.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### Cloud Computing Networks

An exemplary cloud computing network may include plural different networks. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

Exemplary cloud computing features include the ability to unilaterally provision computing capabilities, such as server time and network storage, as needed automatically without requiring human interaction with each network server on the cloud communications network 120. Electronic list capabilities are available over plural broadband communications networks and accessed through standard mechanisms that promote use by heterogeneous thin or thick client platforms 110 (e.g., mobile phones, smart phones, tablet computers, laptops, PDAs, etc.). The broadband network access includes high speed network access such as 3G and/or 4G wireless and/or wired and broadband and/or ultra-broad band (e.g., WiMAX, etc.) network access. Electronic list computing resources are pooled to serve multiple electronic referrers using a multi-tenant model, with different physical and virtual resources dynamically assigned and reassigned according to electronic list demand. There is a sense of location independence in that the electronic referrer generally has no control or knowledge over the exact location of the provided electronic list resources but may be able to specify location at a higher level of abstraction (e.g., country, state, or datacenter). Examples of pooled resources include storage, processing, memory, network bandwidth, virtual server network device and virtual target network devices. Capabilities can be rapidly and elastically provisioned, in some cases automatically, to quickly scale out and rapidly released to quickly scale in for electronic lists. To the electronic referrer, the electronic list capabilities available for provisioning appear to be unlimited and can be used in any quantity at any time. Cloud computing systems automatically control and optimize resource use by leveraging a metering capability at some level of abstraction appropriate to the type of electronic lists (e.g., storage, processing, bandwidth, custom electronic list systems, etc.). Electronic list usage is monitored, controlled, and reported providing transparency for both the electronic list service provider and the electronic refer of the utilized electronic referrer service.

Exemplary cloud computing service models include the capability to use the provider's applications running on a cloud infrastructure. The cloud computing applications, are accessible from the server network device from various client devices 110 through a thin client interface such as a web browser, etc. The user does not manage or control the underlying cloud infrastructure including network, servers, operating systems, storage, or even individual application capabilities, with the possible exception of limited user-specific application configuration settings. Cloud Computing Infrastructure may also provide the capability for the user to provision processing, storage, networks and other fundamental computing resources where the consumer is able to deploy and run arbitrary software, which can include operating systems and applications. The user does not manage or control the underlying cloud infrastructure but has control over operating systems, storage, deployed applications, and possibly limited control of select networking components (e.g., host firewalls, etc.). Cloud Computing Platform may also provide the capability for the user to deploy onto the cloud infrastructure created or acquired applications created using programming languages and tools supported servers. The user need not manage or control the underlying cloud infrastructure including network, servers, operating systems, or storage, but has control over the deployed applications and possibly application hosting environment configurations. Using Cloud software for the electronic list system takes full advantage of the cloud paradigm by being service oriented with a focus on statelessness, low coupling, modularity, and semantic interoperability for providing electronic lists.

The wireless interfaces on smart devices and network devices 110 may include but are not limited to, 3G and/or 4G IEEE 802.11a, 802.11b, 802.11g, 802.11n, 802.15.4 (ZigBee), “Wireless Fidelity” (Wi-Fi), “Worldwide Interoperability for Microwave Access” (WiMAX), ETSI High Performance Radio Metropolitan Area Network (HIPERMAN) or “RF Home” wireless interfaces. In another embodiment of the present invention, the wireless sensor device may include an integral or separate Bluetooth and/or infra data association (IrDA) module for wireless Bluetooth or wireless infrared communications. However, the present invention is not limited to such an embodiment and other 802.11xx and other types of wireless interfaces can also be used.

As is known in the art, an 802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11XX interfaces can also be used and the present invention is not limited to the 802.11 protocols defined. The IEEE 802.11a, 802.11b and 802.11g standards are incorporated herein by reference.

As is known in the art, 802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, fully handshaked protocol for transfer reliability, power management to ensure low power consumption for multi-month to multi-year battery usage and up to 16 channels in the 2.4 GHz Industrial, Scientific and Medical (ISM) band (Worldwide), 10 channels in the 915 MHz (US) and one channel in the 868 MHz band (Europe). The IEEE 802.15.4-2003 standard is incorporated herein by reference. More information on 802.15.4 and ZigBee can be found at the domain name “www.ieee802.org” and “www.zigbee.org” respectively.

As is known in the art, WiMAX is an industry trade organization formed by leading communications component and equipment companies to promote and certify compatibility and interoperability of broadband wireless access equipment that conforms to the IEEE 802.16XX (and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX (hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the domain name “www.wimaxforum.org.” WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the domain name “www.etsi.org.” ETSI HIPERMAN can be used to provide a WLP.

In one embodiment, of the invention, the wireless interfaces also include wireless personal area network (WPAN) interfaces. As is known in the art, a WPAN is a personal area network for interconnecting devices centered around an individual person's devices in which the connections are wireless. A WPAN interconnects all the ordinary computing and communicating devices that a person has on their desk (e.g. computer, etc.) or carry with them (e.g., PDA, mobile phone, smart phone, table computer two-way pager, etc.)

A key concept in WPAN technology is known as “plugging in.” In the ideal scenario, when any two WPAN-equipped devices come into close proximity (within several meters and/or feet of each other) or within a few miles and/or kilometers of a central server (not illustrated), they can communicate via wireless communications as if connected by a cable. WPAN devices can also lock out other devices selectively, preventing needless interference or unauthorized access to secure information. Zigbee is one wireless protocol used on WPAN networks such as cloud communications network 120. By virtual of this technology, the network devices 100 of a particular user can synch with one another even when the devices are not connected to the cloud 120, if desired.

The wired interfaces include wired interfaces and corresponding networking protocols for wired connections to the Public Switched Telephone Network (PSTN) and/or a cable television network (CATV) and/or satellite television networks (SATV) including HDTV that connect the network devices 110 via one or more twisted pairs of copper wires, digital subscriber lines (e.g. DSL, ADSL, VDSL, etc.) coaxial cable, fiber optic cable, other connection media or other connection interfaces. The PSTN is any public switched telephone network. The CATV is any cable television network provided by the Comcast, Time Warner, etc. However, the present invention is not limited to such wired interfaces and more, fewer and/or other wired interfaces can be used to practice the invention.

Network devices and/or wired and wireless interfaces of the present invention include security and encryption for secure communications on the cloud communications network 120. An encryption engine 178 may be used to facilitate encryption. Wireless Encryption Protocol (WEP) (also called “Wired Equivalent Privacy) is a security protocol for WiLANs defined in the IEEE 802.11b standard. WEP is cryptographic privacy algorithm, based on the Rivest Cipher 4 (RC4) encryption engine 178, used to provide confidentiality for 802.11b wireless data.

As is known in the art, RC4 is cipher designed by RSA Data Security, Inc. of Bedford, Mass., which can accept encryption keys of arbitrary length, and is essentially a pseudo random number generator with an output of the generator being XORed with a data stream to produce encrypted data.

The 802.11i is based on 802.1x port-based authentication for user and device authentication. The 802.11i standard includes two main developments: Wi-Fi Protected Access (WPA) and Robust Security Network (RSN).

WPA uses the same RC4 underlying encryption algorithm as WEP. However, WPA uses TKIP to improve security of keys used with WEP. WPA keys are derived and rotated more often than WEP keys and thus provide additional security. WPA also adds a message-integrity-check function to prevent packet forgeries.

RSN uses dynamic negotiation of authentication and selectable encryption algorithms between wireless access points and wireless devices. The authentication schemes proposed in the draft standard include Extensible Authentication Protocol (EAP). One proposed encryption algorithm is an Advanced Encryption Standard (AES) encryption algorithm.

Dynamic negotiation of authentication and encryption algorithms lets RSN evolve with the state of the art in security, adding algorithms to address new threats and continuing to provide the security necessary to protect information that WiLANs carry.

The NIST developed a new encryption standard, the Advanced Encryption Standard (AES) to keep government information secure. AES is intended to be a stronger, more efficient successor to Triple Data Encryption Standard (3DES). More information on NIST AES can be found at the domain name “www.nist.gov/aes.”

As is known in the art, DES is a popular symmetric-key encryption method developed in 1975 and standardized by ANSI in 1981 as ANSI X.3.92, the contents of which are incorporated herein by reference. As is known in the art, 3DES is the encrypt-decrypt-encrypt (EDE) mode of the DES cipher algorithm. 3DES is defined in the ANSI standard, ANSI X9.52-1998, the contents of which are incorporated herein by reference. DES modes of operation are used in conjunction with the NIST Federal Information Processing Standard (FIPS) for data encryption (FIPS 46-3, October 1999), the contents of which are incorporated herein by reference.

The NIST approved a FIPS for the AES, FIPS-197. This standard specified “Rijndael” encryption as a FIPS-approved symmetric encryption algorithm that may be used by U.S. Government organizations (and others) to protect sensitive information. The NIST FIPS-197 standard (AES FIPS PUB 197, November 2001) is incorporated herein by reference. The NIST approved a FIPS for U.S. Federal Government requirements for information technology products for sensitive but unclassified (SBU) communications. The NIST FIPS Security Requirements for Cryptographic Modules (FIPS PUB 140-2, May 2001) is incorporated herein by reference.

As is known in the art, RSA is a public key encryption system which can be used both for encrypting messages and making digital signatures. The letters RSA stand for the names of the inventors: Rivest, Shamir and Adleman. For more information on RSA, see U.S. Pat. No. 4,405,829, now expired, incorporated herein by reference.

As is known in the art, “hashing” is the transformation of a string of characters into a usually shorter fixed-length value or key that represents the original string. Hashing is used to index and retrieve items in a database because it is faster to find the item using the shorter hashed key than to find it using the original value. It is also used in many encryption algorithms.

Secure Hash Algorithm (SHA), is used for computing a secure condensed representation of a data message or a data file. When a message of any length <2.sup.64 bits is input, the SHA-1 produces a 160-bit output called a “message digest.” The message digest can then be input to other security techniques such as encryption, a Digital Signature Algorithm (DSA) and others that generate or verifies a security mechanism for the message. SHA-512 outputs a 512-bit message digest. The Secure Hash Standard, FIPS PUB 180-1, Apr. 17, 1995, is incorporated herein by reference.

Message Digest-5 (MD-5) takes as input a message of arbitrary length and produces as output a 128-bit “message digest” of the input. The MD5 algorithm is intended for digital signature applications, where a large file must be “compressed” in a secure manner before being encrypted with a private (secret) key under a public-key cryptosystem such as RSA. The IETF RFC-1321, entitled “The MD5 Message-Digest Algorithm” is incorporated here by reference.

As is known in the art, providing a way to check the integrity of information transmitted over or stored in an unreliable medium such as a wireless network is a prime necessity in the world of open computing and communications. Mechanisms that provide such integrity check based on a secret key are called “message authentication codes” (MAC). Typically, message authentication codes are used between two parties that share a secret key in order to validate information transmitted between these parties.

Keyed Hashing for Message Authentication Codes (HMAC), is a mechanism for message authentication using cryptographic hash functions. HMAC is used with any iterative cryptographic hash function, e.g., MD5, SHA-1, SHA-512, etc. in combination with a secret shared key. The cryptographic strength of HMAC depends on the properties of the underlying hash function. The IETF RFC-2101, entitled “HMAC: Keyed-Hashing for Message Authentication” is incorporated here by reference.

As is known in the art, an Electronic Code Book (ECB) is a mode of operation for a “block cipher,” with the characteristic that each possible block of plaintext has a defined corresponding cipher text value and vice versa. In other words, the same plaintext value will always result in the same cipher text value. Electronic Code Book is used when a volume of plaintext is separated into several blocks of data, each of which is then encrypted independently of other blocks. The Electronic Code Book has the ability to support a separate encryption key for each block type.

As is known in the art, Diffie and Hellman (DH) describe several different group methods for two parties to agree upon a shared secret in such a way that the secret will be unavailable to eavesdroppers. This secret is then converted into various types of cryptographic keys. A large number of the variants of the DH method exist including ANSI X9.42. The IETF RFC-2631, entitled “Diffie-Hellman Key Agreement Method” is incorporated here by reference. However, the present invention is not limited to the security or encryption techniques described and other security or encryption techniques can also be used.

As is known in the art, the HyperText Transport Protocol (HTTP) Secure (HTTPs), is a standard for encrypted communications on the World Wide Web. HTTPs is actually just HTTP over a Secure Sockets Layer (SSL). For more information on HTTP, see IETF RFC-2616 incorporated herein by reference.

As is known in the art, the SSL protocol is a protocol layer which may be placed between a reliable connection-oriented network layer protocol (e.g. TCP/IP) and the application protocol layer (e.g. HTTP). SSL provides for secure communication between a source and destination by allowing mutual authentication, the use of digital signatures for integrity, and encryption for privacy. The SSL protocol is designed to support a range of choices for specific security methods used for cryptography, message digests, and digital signatures. The security method are negotiated between the source and destination at the start of establishing a protocol session. The SSL 2.0 protocol specification, by Kipp E. B. Hickman, 1995 is incorporated herein by reference. More information on SSL is available at the domain name See “netscape.com/eng/security/SSL.sub.--2.html.”

As is known in the art, Transport Layer Security (TLS) provides communications privacy over the Internet. The protocol allows client/server applications to communicate over a transport layer (e.g., TCP) in a way that is designed to prevent eavesdropping, tampering, or message forgery. For more information on TLS see IETF RFC-2246, incorporated herein by reference.

In one embodiment, the security functionality includes Cisco Compatible EXtensions (CCX). CCX includes security specifications for makers of 802.11xx wireless LAN chips for ensuring compliance with Cisco's proprietary wireless security LAN protocols. As is known in the art, Cisco Systems, Inc. of San Jose, Calif. is supplier of networking hardware and software, including router and security products. However, the present invention is not limited to such security and encryption methods and more, fewer and/or other types of security and encryption methods can be used to practice the invention.

The events in the methods and systems described herein happen in “real-time.” In this context real-time are completed in a few seconds or less amount of elapsed time from the time the event is requested until the time it is completed.

The methods and systems described herein provide an electronic list system via cloud computing with a cloud communications network using public networks, private networks, community networks and hybrid networks. The cloud communications network provides on-demand self-service, broad network access, resource pooling, rapid elasticity and measured electronic services for electronic lists. The method and system dramatically improve an electronic list infrastructure used by less bandwidth and less processing cycles via the cloud communications network than via a non-cloud communications network.

It should be understood that the architecture, programs, processes, methods and systems described herein are not related or limited to any particular type of computer or network system (hardware or software), unless indicated otherwise. Various types of general purpose or specialized computer systems may be used with or perform operations in accordance with the teachings described herein.

As described above, one exemplary embodiment comprises a non-transitory computer readable medium having stored therein a plurality of instructions for causing one or more processors on one or more network devices to execute the steps of: storing a plurality of user profiles, wherein each user profile has a unique USER ID that allows the user anonymity; storing a plurality of user created lists, each list being associated with just one USER ID and including at list one list item created from input received from the user whose user profile is associated with the USER ID; receiving input from users indicating that a list pertains to a category and storing a record of the category in association with the list; receiving input from a user indicating that a list created by that user is affiliated with a list created by one or more other users and storing a record of the affiliated lists; creating a consolidated list by combining and deduplicating the affiliated lists and storing the consolidated lists in association with the plurality of USER IDs of the users that created the affiliated lists; and allowing users to search the list items user created lists and consolidated lists without compromising the anonymity of the users associated with the USER ID.

An exemplary embodiment from the perspective of a vendor comprises a communication system for exchanging data with an external list service that stores records associated with unique USER IDs, the records stored including user profiles and user created lists; a check-in station for receiving input from USERS, the station comprising hardware for receiving input from a user that includes at least identification of a unique USER ID. Optionally, the check-in station receives may receive biometric input from USERS, wireless input from USERS and/or touchscreen input from USERS. A list query generation system generates queries of an external electronic list system sufficient to obtain at least one list record associated with the USER ID input; memory for storing list records received from the electronic list service; an inventory system that includes electronically searchable records sufficient to identify products in inventory and the location of products in the store; optionally the inventory system may include electronically searchable records sufficient to identify the current price of products in inventory; a shopping list display generator for receiving input including at least the list items associated with the USER ID, initiating an inventory system query and outputting a shopping list showing the list items that are available and the store location of the list items. Optionally, the output may be a printed list; an electronic signal that causes the list to be displayed on a user device or output displayed on an electronic display.

Another exemplary embodiment includes a method of processing an order received from a smart device in a vehicle where the smart device is equipped with location determination equipment, a display, user interface and communication equipment, the method comprising the steps of: receiving a vendor location query from a user, the vendor location request identifying at least a vendor category and the user location; identifying at least one vendor satisfying the vendor location query and transmitting vendor information to the user; obtaining a vendor selection from the user; sending menu information to the user based on the vendor selection obtained from the user; creating and storing an order list based on item selections received from at least one user; optionally alerting affiliated users of the pending order and providing the affiliated users an opportunity to create an order list and consolidating all lists received; transmitting the order list to vendor and, optionally, including payment information, vehicle location information and/or vehicle identification information; receiving from the vendor and providing to the user location pick-up information that may, optionally, include a specific unique pick-up location and optionally tracking the location of the user vehicle and the order progress and exchanging information with the user and vendor concerning the same.

The engines described herein may be implemented in software, firmware, hardware, or any combination thereof. The engines may run n and across various platforms. The system can be implemented to run on any type or combination of processing device including, but not limited to, a computer, workstation, distributed computing system, embedded system, stand-alone electronic device, networked device, mobile device, set-top box, television, or other type of processor or computer system. Further, a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm. Embodiments may be implemented via a set of programs running in parallel on multiple machines.

Embodiments may be directed to computer products comprising software stored on any computer usable medium. Such software, when executed in one or more data processing device, causes a data processing device(s) to operate as described herein.

The summary and abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa. The breadth and scope of the present invention should not be limited by any of the above-described exemplary embodiments.

What is claimed is:

1. A non-transitory computer readable medium having stored therein a plurality of instructions for causing one or more processors on one or more network devices to execute the steps of:
storing a plurality of user profiles, wherein each user profile has a unique USER ID that allows the user anonymity
storing a plurality of user created lists, each list being associated with just one USER ID and including at list one list item created from input received from the user whose user profile is associated with the USER ID
receiving input from users indicating that a list pertains to a category and storing a record of the category in association with the list
receiving input from a user indicating that a list created by that user is affiliated with a list created by one or more other users and storing a record of the affiliated lists
creating a consolidated list by combining and deduplicating the affiliated lists and storing the consolidated lists in association with the plurality of USER IDs of the users that created the affiliated lists
allowing users to search the list items user created lists and consolidated lists without compromising the anonymity of the users associated with the USER ID.

2. The non-transitory computer readable medium of claim 1 further comprising instructions stored thereon for causing one or more processors on one or more network devices to execute the steps of:
generating consolidated lists of affiliated users;
generating an inventory query based on items from the consolidated list;
displaying available goods and location;
polling other users by sending a message to select users to solicit, prompt or otherwise encourage the recipient users to generate a user list item.

3. The non-transitory computer readable medium of claim 1 further comprising instructions stored thereon for causing one or more processors on one or more network devices to execute the steps of implementing a distributed order fulfillment and distribution process comprising the steps of
receiving a signal indicating that a user have checked in at a remote location;
determining whether the user is qualified as at least one of an authorized affiliate or trusted driver eligible to pick up orders on behalf of others;
if the user is qualified as at least one of an authorized affiliate or trusted driver eligible to pick up orders on behalf of others displaying orders that are available for pickup by the user;
receiving a user selection; and
for each order selected transmitting order details to the user.

4. A system for exchanging data with an external list service that stores records associated with unique USER IDs, the records stored including user profiles and user created lists, the system comprising:
a check-in station for receiving input from USERS, the station comprising hardware for receiving input from a user that includes at least identification of a unique USER ID;
memory for storing list records received from the electronic list service;
an inventory system that includes electronically searchable records sufficient to identify products in inventory and the location of products in the store; and
a non-transitory computer-readable medium embodying a program executable in a computing device that includes code that generates queries of an external electronic list system sufficient to obtain at least one list record associated with the USER ID input and logic for receiving input including at least the list items associated with the USER ID, initiating an inventory system query and generating an output a shopping list showing the list items that are available and the store location of the list items.

5. The system of claim 4, wherein the check-in station receives biometric input from USERS.

6. The system of claim 4, wherein the check-in station receives touchscreen input from USERS

7. The system of claim 4, wherein the output is a signal that causes the list to be displayed on a user device.

8. The system of claim 4, further comprising hardware for tracking the location of a hand held user device and communicating with the hand held user device to provide in store direction guidance based on the location of the hand held device and the location of a selected list item.

10. The system of claim 4, the inventory system further includes electronically searchable records sufficient to identify the current price of products in inventory.

11. The system of claim 4, wherein the non-transitory computer-readable medium further embodies a program executable in a computing device that includes code that executes the steps of implementing a distributed order fulfillment and distribution process comprising the steps of:
receiving a signal indicating that a user have checked in at a remote location;
determining whether the user is qualified as at least one of an authorized affiliate or trusted driver eligible to pick up orders on behalf of others;
if the user is qualified as at least one of an authorized affiliate or trusted driver eligible to pick up orders on behalf of others displaying orders that are available for pickup by the user;
receiving a user selection; and
for each order selected transmitting order details to the user.

12. A system comprising a non-transitory computer readable medium having stored therein a plurality of instructions for causing one or more processors on one or more network devices to process an order received from a smart device in a vehicle where the smart device is equipped with location determination equipment, a display, user interface and communication equipment, by executing the steps of:
receiving a vendor location query from a user, the vendor location request identifying at least a vendor category and the user location;
identifying at least one vendor satisfying the vendor location query and transmitting vendor information to the user;
obtaining a vendor selection from the user;
sending menu information to the user based on the vendor selection obtained from the user; creating and storing an order list based on item selections received from at least one user; transmitting the order list to vendor and, optionally, including payment information, vehicle location information and/or vehicle identification information; receiving from the vendor and providing to the user location pick-up information.

13. The system of claim 12, wherein the pick-up information includes a specific unique pick-up location

14. The system of claim 12, further comprising the steps of tracking the location of the user vehicle and the order progress and exchanging information with the user and vendor concerning the same.

15. The system of claim 12, further comprising the steps of alerting affiliated users of the pending order and providing the affiliated users an opportunity to create an order list and consolidating all lists received.
